(19) United States
(12) Patent Application Publication
(10) Pub. No.: US 2014/0214722 A1
(43) Pub. Date: Jul. 31, 2014

(54) REAL TIME EVALUATION OF FINANCIAL RETURNS BASED ON NEARLY ELLIPTICAL MODELS

(71) Applicant: THE RESEARCH FOUNDATION OF THE STATE UNIVERSITY OF NEW YORK, Albany, NY (US)

(72) Inventors: JAMES GLIMM, New York, NY (US); Jimmie Goode, Shreveport, LA (US); Beiyu Lin, Stony Brook, NY (US); Nicholas Pezolano, Middle Village, NY (US); Svetlozar Rachev, Setauket, NY (US)

(73) Assignee: THE RESEARCH FOUNDATION OF THE STATE UNIVERSITY OF NEW YORK, Albany, NY (US)

(21) Appl. No.: 14/163,674

(22) Filed: Jan. 24, 2014

Related U.S. Application Data
(60) Provisional application No. 61/756,799, filed on Jan. 25, 2013.

(51) Int. Cl. G06Q 40/06

(52) U.S. Cl. CPC G06Q 40/06
USPC 705/36 R

(57) ABSTRACT

A computer-implemented method for forecasting losses in a financial portfolio includes estimating parameters of an autoregressive-moving-average generalized-autoregressive-conditional-heteroscedastic (ARMA-GARCH) model for each individual asset in a financial portfolio by performing a parallel maximum likelihood estimation, estimating parameters of a copula dependence structure for standardized residuals of the ARMA-GARCH model, and estimating a Value-at-Risk (VaR) for the financial portfolio from the ARMA-GARCH model parameters and the copula dependence structure parameters.

### CROSS REFERENCE TO RELATED UNITED STATES APPLICATIONS

This application claims priority from “Real Time Evaluation of Financial Returns based on Nearly Elliptical Models”, U.S. Provisional Application No. 61/756,799 of Glimm, et al., filed Jan. 25, 2013, the contents of which are herein incorporated by reference in their entirety.

### TECHNICAL FIELD

This disclosure is directed to systems and methods for financial portfolio forecasting.

### DISCUSSION OF THE RELATED ART

Financial industry participants and regulators use mathematical models to forecast the risk associated with portfolios that may include potentially millions of assets. The standard metric for representing this risk is known as Value-at-Risk (VaR), which expresses the minimum possible loss at a given level of mathematical confidence. Existing methods for estimating risk measures such as VaR for large portfolios have inherent limitations in predictive accuracy and are either slow or inaccurate, due to low dimensional and/or Gaussian approximations used to render the problem computationally feasible. This fact may lead to overly cautious and inefficient decisions based on existing methods.

Long computing times can also limit the frequency at which VaR forecasts can be updated, and practitioners often perform such computations overnight between trading sessions. Inaccuracies introduced by the Gaussian approximation or by dimension reduction techniques require large safety margins to be applied to VaR forecasts, thereby exaggerating the true VaR and requiring excess reserve capital to be held back in less volatile market conditions.

To model the probability distribution of a portfolio return, one models the returns of each asset and the dependence structure among the assets. Autoregressive moving average (ARMA) models provide a simple description of a stationary stochastic process, such as a time series of asset returns, in terms of two polynomials, one for auto-regression and a second for a moving average. In addition, autoregressive conditional heteroscedastic (ARCH) models and their extensions to generalized ARCH (GARCH) models capture two stylistic features of financial returns: volatility clustering and excess leptokurtosis. ARMA-GARCH models have become an industry standard for modeling asset returns, with the addition of more realistic innovation distributions being a more recent development.

A copula is a multivariate probability distribution function that allows one to model the dependence between each marginal random variable separately from the marginals themselves. To forecast VaR for a portfolio of assets where the assumed asset return process is ARMA-GARCH, the dependence among each asset's ARMA-GARCH innovation is modeled with a copula function. In this way, one can account for the heavy tails and volatility clustering of the individual assets separately from the dependence structure among them, with its own heavy tails. This is referred to as a copula ARMA-GARCH model. These types of models have seen extensive use in the financial industry.

Conventional high speed risk assessment methods are generally limited to Gaussian or low dimensional factor methods, and have not been previously applied to the heavy tailed and more accurate distributions used for large asset class risk assessment.

### SUMMARY

Exemplary embodiments of the disclosure as described herein generally include systems and methods for forecasting in real-time the VaR of portfolios that include a very large number of assets through explicit multivariate models and which requires no inaccuracy-inducing dimension reduction or Gaussian techniques. Embodiments of present disclosure provides real time evaluation of multivariate heavy tailed stochastic models based on elliptical modeling of financial returns, as is needed for risk management and portfolio optimization. Embodiments of the disclosure assume that the returns of each asset follow an ARMA-GARCH process, and are applicable for innovations drawn from a class of nearly elliptic distributions. However, methods according to embodiments of the disclosure for the rapid evaluation of large numbers of assets may be applied to many other aspects of portfolio management, including portfolio optimization and multiperiod forecasting of returns, in addition to the risk measures herein disclosed. Herein, a financial return is the gain or loss from a portfolio position for a single period, which could be a day or an hour, or a shorter period. Elliptical models include a number of models which have a higher probability of extreme events, also known as heavy tails, which can more accurately represent financial return data than do existing real time evaluation methods. Existing methods for real time evaluation of large systems are mainly restricted to Gaussian models, which due to their assumption of weak correlations, show rapid decay of probabilities for extreme events, known in the art as thin tails. Such models display poor fit to financial return data. Embodiments of the present disclosure allow portfolio management to include risk assessment and optimization for large portfolios at a speed comparable to commonly used Gaussian models. Back testing results for risk assessment show an improved accuracy which allows up to a three-fold reduction of reserve capital requirements during market quiet periods relative to Gaussian models, which is consistent with Basel III requirements.

According to an aspect of the disclosure, there is provided a computer-implemented method for forecasting losses in a financial portfolio, including performing a maximum likelihood estimation of parameter values \vec{θ}=(c, a₁, . . . , aₚ, b₁, . . . , b_{q}, ρ₁, . . . , ρᵣ, φ₁, . . . , φₛ, λ, χ, ψ, γ) for a univariate generalized hyperbolic distribution for a random variable x given by

$$f ( x ) = c \frac{{K}_{λ - ( d / 2 )} ( \sqrt{( χ + {( x - μ )}^{′} {\sum }^{- 1} ( x - μ ) ) ( ψ + {γ}^{′} {\sum }^{- 1} γ )} ) {e}^{{( x - μ )}^{′} {\sum }^{- 1} γ}}{{( \sqrt{( χ + {( x - μ )}^{′} {\sum }^{- 1} ( x - μ ) ) ( ψ + {γ}^{′} {\sum }^{- 1} γ )} )}^{( d / 2 ) - λ}} ,$$

where K_{λ} denotes a modified Bessel function of the third kind with index λ, Σ is a covariance matrix, and c is a normalizing constant defined as

$$c = \frac{{( \sqrt{χψ} )}^{- λ} {{ψ}^{λ} ( ψ + {γ}^{′} {\sum }^{- 1} γ )}^{( d / 2 ) - λ}}{{( 2 π )}^{d / 2} {\vert \sum \vert}^{1 / 2} {K}_{λ} ( \sqrt{χψ} )} ,$$

where parameters c, a₁, . . . , aₚ, b₁, . . . , b_{q}, ρ₁, . . . , ρᵣ, φ₁, . . . , φₛ, are parameters of an ARMA(p,q)-GARCH(r,s) model that describes an asset return rₜ, expressed as rₜ=+μ+Σᵢ₌₁^{p}aᵢrₜ₋₁+Σⱼ₌₁^{q}bⱼεₜ₋ⱼ+εₜ, σₜ²=ω+Σᵢ₌₁^{r}ρᵢεₜ₋ᵢ²+Σⱼ₌₁^{s}φⱼσₜ₋ⱼ², εₜ=σₜuₜ, where μ∈R is a conditional constant mean, ω≧0 is a conditional variance, ρᵢ≧0, φᵢ≧0, εₜ are innovations with standardized residuals uₜ having mean E[u]=0, and variance var[u]=1, and σₜ² are conditional variances, transforming the standardized residuals uₜ into copula space using \vec{U}=(F₁(u_{t,1}), . . . , F_{d}(u_{t,d}))_{t=1, . . . , T}′, where Fᵢ is a cumulative density function of the normalized innovation distribution ƒ(x), estimating a dependence structure for \vec{U}, and calculating a portfolio risk forecast from the generalized hyperbolic distribution parameter values \vec{θ}=(c, a₁, . . . , aₚ, b₁, . . . , b_{q}, ρ₁, . . . , ρᵣ, φ₁, . . . , φₛ, λ, χ, ψ, γ) and parameters of the dependence structure.

According to a further aspect of the disclosure, performing a maximum likelihood estimation of parameter values \vec{θ}=(c, a₁, . . . , aₚ, b₁, . . . , b_{q}, ρ₁, . . . , ρᵣ, φ₁, . . . , φₛ, λ, χ, ψ, γ) comprises solving

$$l ( {θ}^{->} \vert {u}_{1} , … , {u}_{T} ) = {\sum }_{t = 1}^{T} log ( \frac{f ( {u}_{t} \vert {θ}^{->} )}{{σ}_{t}} )$$

subject to a constraint that Σᵢ₌₁^{r}ρᵢ+Σⱼ₌₁^{s}φⱼ, where ƒ( ) is a probability density function of a distribution for {uₜ}_{t=1, . . . , T}, using a nonlinearly constrained gradient-based maximization with a stopping criteria being a relative tolerance of 10⁻⁶ for all variables and an absolute tolerance of 10⁻⁶ for the log-likelihood objective function.

According to a further aspect of the disclosure, the nonlinearly constrained gradient-based maximization uses a sequential quadratic programming (SQP) algorithm, and where a gradient of the constraint may be computed with adaptive central finite differences using an initial step size of 10⁻⁶ for all parameters.

According to a further aspect of the disclosure, performing a maximum likelihood estimation of parameter values \vec{θ}=(c, a₁, . . . , aₚ, b₁, . . . , b_{q}, ρ₁, . . . , ρᵣ, φ₁, . . . , φₛ, λ, χ, ψ, γ) for the univariate generalized hyperbolic distribution includes initializing parameter values \vec{θ}^{[0]=(c, a}₁, . . . , aₚ, b₁, . . . , b_{q}, ρ₁, . . . , ρᵣ, φ₁, . . . , φₛ, λ, χ, ψ, γ) for the generalized hyperbolic distribution, calculating weights

$${\overline{δ}}^{[ k ]} = \frac{1}{n} {\sum }_{i = 1}^{n} {δ}_{i}^{[ k ]} , \\ and$$

$${\overline{η}}^{[ k ]} = \frac{1}{n} {\sum }_{i = 1}^{n} {η}_{i}^{[ k ]}$$

where δᵢ^{[k]}=E(Wᵢ⁻¹|Xᵢ;θ^{[k]}) and ηᵢ^{[k]}=E(Wᵢ|Xᵢ;θ^{[k]}) for a random variable X, and a non-negative scalar random variable Wᵢ distributed as ƒ(x), where k is an iteration index, updating parameter γ as

$${γ}^{[ k + 1 ]} = \frac{{n}^{- 1} {\sum }_{i = 1}^{n} {δ}_{i}^{[ k ]} ( \overline{X} - {X}_{i} )}{{\overline{δ}}^{[ k ]} {\overline{η}}^{[ k ]} - 1} ,$$

updating the mean μ and covariance matrix Σ as

$${μ}^{[ k + 1 ]} = \frac{{n}^{- 1} {\sum }_{i = 1}^{n} {δ}_{i}^{[ k ]} {X}_{i} - {γ}^{[ k + 1 ]}}{{\overline{δ}}^{[ k ]}}$$

$$and$$

$${\sum }^{[ k + 1 ]} = \frac{{\vert S \vert}^{1 / d} Ψ}{Ψ}$$

where

$$Ψ = \frac{1}{n} {\sum }_{i = 1}^{n} {δ}_{i}^{[ k ]} ( {X}_{i} - {μ}^{[ k + 1 ]} ) {( {X}_{i} - {μ}^{[ k + 1 ]} )}^{′} - {\overline{η}}^{[ k ]} {γ}^{[ k + 1 ]} {γ}^{[ k + 1 ] ′} ,$$

calculating weights δᵢ^{[k,2]}, ηᵢ^{[k,2]} and ξ^{[k,2]} from δᵢ^{[k,2]}=E(Wᵢ⁻¹|Xᵢ;θ^{[k,2]}), ηᵢ^{[k,2]}=E(Wᵢ|Xᵢ;θ^{[k,2]}), and ξᵢ^{[k,2]}=E(ln(Wᵢ)|Xᵢ;θ^{[k,2]}), where θ^{[k,2]}=(λ^{[k]}, χ^{[k]}, ψ^{[k]}, μ^{[k+1]}, Σ^{[k+1]}, γ^{[k+1]})′, and determining values of parameters λ, χ, ψ that maximize

$$( λ - 1 ) {\sum }_{i = 1}^{n} {ξ}_{i}^{[ k , 2 ]} - \frac{1}{2} χ {\sum }_{i = 1}^{n} {δ}_{i}^{[ k , 2 ]} - \frac{1}{2} ψ {\sum }_{i = 1}^{n} {η}_{i}^{[ k , 2 ]} - \frac{1}{2} n λ ln ( χ ) + \frac{1}{2} n λ ln ( ψ ) - n ln ( 2 {K}_{λ} ( \sqrt{χψ} ) ) .$$

According to a further aspect of the disclosure, γ^{[k+1]}=0 for a symmetric model.

According to a further aspect of the disclosure, ψ=0, λ=v/2 with a degrees of freedom parameter v>4, and χ=v.

According to a further aspect of the disclosure, the method is implemented on a computer having at least one multi-core processor, the cores are utilized in a master/slave layout where several master processes distribute data for W and X to many slave processes, where each slave received data for a single asset of the financial portfolio, and each slave process returns an estimate of the parameters \vec{θ}^{[k]}=(c, a₁, . . . , aₚ, b₁, . . . , b_{q}, ρ₁, . . . , ρᵣ, φ₁, . . . , φₛ, λ, χ, ψ, γ) to its master process.

According to a further aspect of the disclosure, estimating parameter values \vec{θ}=(c, a₁, . . . , aₚ, b₁, . . . , b_{q}, ρ₁, . . . , ρᵣ, φ₁, . . . , φₛ, λ, χ, ψ, γ) of a copula dependence structure for the standardized residuals uₜ includes initializing parameter values \vec{θ}^{[0]=(c, a}₁, . . . , aₚ, b₁, . . . , b_{q}, ρ₁, . . . , ρᵣ, φ₁, . . . , φₛ, λ, χ, ψ, γ) for a multivariate generalized hyperbolic distribution, calculating weights

$${\overline{δ}}^{[ k ]} = \frac{1}{n} {\sum }_{i = 1}^{n} {δ}_{i}^{[ k ]} , \\ and$$

$${\overline{η}}^{[ k ]} = \frac{1}{n} {\sum }_{i = 1}^{n} {η}_{i}^{[ k ]}$$

where δᵢ^{[k]}=E(Wᵢ⁻¹|Xᵢ;θ^{[k]}) and ηᵢ^{[k]}=E(Wᵢ|Xᵢ;θ^{[k]}) for a non-negative scalar random variable Wᵢ distributed as ƒ(x), where k is an iteration index, updating parameter γ as

$${γ}^{[ k + 1 ]} = \frac{{n}^{- 1} {\sum }_{i = 1}^{n} {δ}_{i}^{[ k ]} ( \overline{X} - {X}_{i} )}{{\overline{δ}}^{[ k ]} {\overline{η}}^{[ k ]} - 1} ,$$

updating the mean μ and covariance matrix Σ as

$${μ}^{[ k + 1 ]} = \frac{{n}^{- 1} {\sum }_{i = 1}^{n} {δ}_{i}^{[ k ]} {X}_{i} - {γ}^{[ k + 1 ]}}{{\overline{δ}}^{[ k ]}}$$

$$and$$

$${\sum }^{[ k + 1 ]} = \frac{{\vert S \vert}^{1 / d} Ψ}{Ψ}$$

where

$$Ψ = \frac{1}{n} {\sum }_{i = 1}^{n} {δ}_{i}^{[ k ]} ( {X}_{i} - {μ}^{[ k + 1 ]} ) {( {X}_{i} - {μ}^{[ k + 1 ]} )}^{′} - {\overline{η}}^{[ k ]} {γ}^{[ k + 1 ]} {γ}^{[ k + 1 ] ′} ,$$

calculating weights δᵢ^{[k,2]}, ηᵢ^{[k,2]} and ξ^{[k,2]} from δ^{[k,2]}=E(Wᵢ⁻¹|X₁;θ^{[k,2]}), ηᵢ^{[k,2]}=E(Wᵢ|Xᵢ;θ^{[k,2]}), and ξᵢ^{[k,2]}=E(ln(Wᵢ)|Xᵢ;θ^{[k,2]}), where θ^{[k,2]}=(λ^{[k]}, χ^{[k]}, ψ^{[k]}, μ^{[k+1]}, Σ^{[k+1]}, γ^{[k+1]})′, and determining values of parameters λ, χ, ψ that maximize

$$( λ - 1 ) {\sum }_{i = 1}^{n} {ξ}_{i}^{[ k , 2 ]} - \frac{1}{2} χ {\sum }_{i = 1}^{n} {δ}_{i}^{[ k , 2 ]} - \frac{1}{2} ψ {\sum }_{i = 1}^{n} {η}_{i}^{[ k , 2 ]} - \frac{1}{2} n λ ln ( χ ) + \frac{1}{2} n λln ( ψ ) - n ln ( 2 {K}_{λ} ( \sqrt{χ ψ} ) ) .$$

According to a further aspect of the disclosure, the univariate generalized to hyperbolic distribution is a one-dimensional Student's t distribution where ψ=0, λ=v/2 with a degrees of freedom parameter v>4, and χ=v, and further comprising performing the maximum likelihood estimation for each univariate Student's t distribution to obtain parameters (γᵢ, μᵢ, vᵢ, σᵢ) for i=1, . . . , d where d is a number of dimensions, estimating v from

$$v = \frac{1}{d} {\sum }_{i = 1}^{d} {v}_{i} ,$$

estimating a covariance Σ from

$$\sum = \frac{v - 2}{v} ( cov ( X ) - \frac{2 {v}^{2}}{{( v - 2 )}^{2} ( v - 4 )} {γγ}^{′} )$$

where X is a random vector, and adjusting Σ to be positive definite.

According to a further aspect of the disclosure, a dependence structure for \vec{U} is estimated from

$$f ( {X}^{->} ) = c \frac{{K}_{\frac{v + d}{2}} ( \sqrt{v + {( {X}^{->} - {μ}^{->} )}^{′} {\sum }^{- 1} ( {X}^{->} - {μ}^{->} ) ) {{γ}^{->}}^{′} {\sum }^{- 1} {γ}^{->}} exp ( {X}^{->} - {μ}^{->} ) {\sum }^{- 1} {γ}^{->} )}{{( \sqrt{( v + {( {X}^{->} - {μ}^{->} )}^{′} {\sum }^{- 1} ( {X}^{->} - {μ}^{->} ) ) {{γ}^{->}}^{′} {\sum }^{- 1} {γ}^{->}} )}^{- \frac{v + d}{2}} {( 1 + \frac{{( {X}^{->} - {μ}^{->} )}^{′} {\sum }^{- 1} {γ}^{->}}{v} )}^{\frac{v + d}{2}}}$$

where Kₐ is a modified Bessel function of the third kind, and c is a normalizing constant defined as

$$c = \frac{{2}^{\frac{2 - ( v + d )}{2}}}{Γ ( \frac{v}{2} ) {( π v )}^{d / 2} {\vert \sum \vert}^{1 / 2}} .$$

According to a further aspect of the disclosure, the ARMA-GARCH model has a nearly elliptical distribution, and calculating a portfolio risk forecast includes drawing a plurality N of independent random samples from the dependence structure for \vec{U},

transforming these samples into copula space using a sample cumulative distribution function Fₖ of a k-th marginal using

$${F}_{k} ( x ) = \frac{1}{n} {\sum }_{j = - 1}^{n} {1}_{\{ {S}_{j , k \leq x} \}} ,$$

forecasting \vec{X}ⱼ=(r_{t+1,1}, . . . , r_{t+1,d})_{j=1, . . . , n} for each asset using the estimated parameter values \vec{θ}, and calculating a Value-at-Risk VaR from G(VaRₛ)=∫_{VaR}_{ₛ}^{∞}ƒ_{\tilde{Y}}_{ₛ}(y)dy+α−1 where α is a confidence level for the VaR, \tilde{Y}ₛ is defined as \tilde{Y}ₛ=\tilde{Y}− [symbol] \vec{w}, \vec{μ} [symbol] where \tilde{Y}= [symbol] \vec{w}, \vec{X} [symbol] , \vec{w}∈R^{d} is a vector of portfolio weights, \tilde{X}_{T}=(r_{T,1}, . . . , r_{T,d}) is a vector of losses for d assets at time T, and \vec{μ} is defined by \tilde{X}_{T}=\vec{μ}_{T-1}+D_{T-1}Ũ_{T}, where D_{T-1}Ũ_{T}=ε_{T} is a time T innovation with D_{T-1}∈R^{d×d} and \vec{μ}_{T-1}∈R^{d} is an ARMA GARCH prediction, and ƒ_{\tilde{Y}}_{ₛ} is a marginal of a probability with respect to \tilde{Y}ₛ.

According to a further aspect of the disclosure, drawing a plurality N of independent random samples from the dependence structure for \vec{U} includes sampling a plurality N of independent d-dimensional vectors from a multivariate normal distribution N(0, Σ), sampling a plurality N of independent random numbers from a Generalized inverse Gaussian distribution

$$f ( x ) = \frac{{{χ}^{- λ} ( \sqrt{χψ} )}^{λ}}{2 {K}_{λ} ( \sqrt{χψ} )} {x}^{λ - 1} exp ( - \frac{1}{2} ( χ {x}^{- 1} + ψ x ) ) ,$$

x>0, and combining these samples to obtain a multivariate generalized hyperbolic sample.

According to a further aspect of the disclosure, the method includes sorting the plurality N of independent random samples into bins indexed by nonspherical directions of the multivariate generalized hyperbolic distribution and by the direction of a spherically transformed portfolio.

According to a further aspect of the disclosure, sampling a plurality N of independent d-dimensional vectors from a multivariate normal distribution N(0, Σ) includes computing a Cholesky decomposition A of Σ, simulating N independent random varieties z=(z₁, . . . , z_{d})′ from N(I_{d}, 0), where I_{d} is a d-dimensional identity matrix, and generating a Gaussian sample from X:=λ+Az, where μ is a sample mean.

According to a further aspect of the disclosure, transforming the standardized residuals uₜ into copula space is performed for an asset on a same computer node as that used to estimate parameter values \vec{θ} for that asset.

According to another aspect of the disclosure, there is provided a computer-implemented method for forecasting losses in a financial portfolio, including estimating parameters of an autoregressive-moving-average generalized-autoregressive-conditional-heteroscedastic (ARMA-GARCH) model for each individual asset in a financial portfolio by performing a parallel maximum likelihood estimation, estimating parameters of a copula dependence structure for standardized residuals of the ARMA-GARCH model, and estimating a Value-at-Risk (VaR) for the financial portfolio from the ARMA-GARCH model parameters and the copula dependence structure parameters.

According to a further aspect of the disclosure, the ARMA-GARCH model is expressed as rₜ=μ+Σᵢ₌₁^{p}aᵢrₜ₋ᵢ+Σⱼ₌₁^{q}bⱼεₜ₋ⱼ+εₜ, σₜ²=ω+Σᵢ₌₁^{r}ρᵢεₜ₋ᵢ²+Σⱼ₌₁^{s}φⱼσₜ₋ⱼ², εₜ=σₜuₜ, where μ∈R is a conditional constant mean, ω≧0 is a conditional variance, ρᵢ≧0, φᵢ≧0, εₜ are innovations with standardized residuals uₜ having mean E[u]=0, and variance var[u]=1, and σₜ² are conditional variances, and where c, a₁, . . . , aₚ, b₁, . . . , b_{q}, ρ₁, . . . , ρᵣ, φ₁, . . . , φₛ, are the model parameters being estimated.

According to a further aspect of the disclosure, the standardized residuals uₜ are sampled from a univariate generalized hyperbolic distribution for a random variable x given by

$$f ( x ) = c \frac{{K}_{λ - ( d / 2 )} ( \sqrt{( χ + {( x - μ )}^{′} {\sum }^{- 1} ( x - μ ) ) ( ψ + {γ}^{′} {\sum }^{- 1} γ )} ) {e}^{{( x - μ )}^{′} {\sum }^{- 1} γ}}{{( \sqrt{( χ + {( x - μ )}^{′} {\sum }^{- 1} ( x - μ ) ) ( ψ + {γ}^{′} {\sum }^{- 1} γ )} )}^{( d / 2 ) - λ}} ,$$

where K_{λ} denotes a modified Bessel function of the third kind with index λ, Σ is a covariance matrix, and c is a normalizing constant defined as

$$c = \frac{{( \sqrt{χψ} )}^{- λ} {{ψ}^{λ} ( ψ + {γ}^{′} {\sum }^{- 1} γ )}^{( d / 2 ) - λ}}{{( 2 π )}^{d / 2} {\vert \sum \vert}^{1 / 2} {K}_{λ} ( \sqrt{χψ} )} .$$

According to a further aspect of the disclosure, performing a parallel maximum likelihood estimation comprises solving

$$l ( \vec{θ} \vert {u}_{1} , … , {u}_{T} ) = {\sum }_{t = 1}^{T} log ( \frac{f ( {u}_{t} \vert \vec{θ} )}{{σ}_{t}} )$$

subject to a constraint that Σᵢ₌₁^{r}ρᵢ+Σⱼ₌₁^{s}φⱼ, where ƒ( ) is a probability density function of a distribution for {uₜ}_{t=1, . . . , T}, using a nonlinearly constrained gradient-based maximization.

According to a further aspect of the disclosure, estimating parameters of a copula dependence structure for standardized residuals of the ARMA-GARCH model comprises transforming the standardized residuals uₜ into copula space using \vec{U}=(F₁(u_{t,1}), . . . , F_{d}(U_{t,d}))_{t=1, . . . , T}′ where Fᵢ is a cumulative density function of the normalized innovation distribution ƒ(x), and estimating a dependence structure for \vec{U} is estimated from a multivariate generalized hyperbolic distribution.

According to a further aspect of the disclosure, the ARMA-GARCH model has a nearly elliptical distribution, and estimating the Value-at-Risk (VaR) for the financial portfolio comprises using uses numerical integration and density function tabulation to compute the VaR via a spherical transformation.

According to a further aspect of the disclosure, estimating a Value-at-Risk (VaR) for the financial portfolio further includes drawing a plurality N of independent random samples from the dependence structure for \vec{U}, transforming these samples into copula space using a sample cumulative distribution function Fₖ of a k-th marginal using

$${F}_{k} ( x ) = \frac{1}{n} {\sum }_{j = - 1}^{n} {1}_{\{ {s}_{j , k} \leq x \}} ,$$

forecasting \vec{X}ⱼ=(r_{t+1,1}, . . . , r_{t+1,d})_{j=1, . . . , n} for each asset using the estimated parameter values \vec{θ}, and calculating a Value-at-Risk VaR from G(VaRₛ)=∫_{VaR}_{ₛ}^{∞}ƒ_{\tilde{Y}}_{ₛ}(y)dy+α−1 where α is a confidence level for the VaR, \tilde{Y}ₛ is defined as \tilde{Y}ₛ=\tilde{Y}− [symbol] \vec{w}, \vec{μ} [symbol] where \tilde{Y}= [symbol] \vec{w}, \tilde{X} [symbol] , \vec{w}∈R^{d} is a vector of portfolio weights, \tilde{X}_{T}=r_{T,1}, . . . , r_{T,d}) is a vector of losses for d assets at time T, and \vec{μ} is defined by \tilde{X}_{T}=\vec{μ}_{T-1}+D_{T-1}Ũ_{T}, where D_{T-1}Ũ_{T}=ε_{T} is a time T innovation with D_{T-1}∈R^{d×d} and \vec{μ}_{T-1}∈R^{d} is an ARMA GARCH prediction, and ƒ_{\tilde{Y}}_{ₛ} is a marginal of a probability with respect to \tilde{Y}ₛ.

According to a further aspect of the disclosure, drawing a plurality N of independent random samples from the dependence structure for \vec{U} includes sampling a plurality N of independent d-dimensional vectors from a multivariate normal distribution N(0, Σ), sampling a plurality N of independent random numbers from a Generalized inverse Gaussian distribution

$$f ( x ) = \frac{{{χ}^{- λ} ( \sqrt{χψ} )}^{λ}}{2 {K}_{λ} ( \sqrt{χψ} )} {x}^{λ - 1} exp ( - \frac{1}{2} ( χ {x}^{- 1} + ψ x ) ) ,$$

x>0, and combining these samples to obtain a multivariate generalized hyperbolic sample.

According to a further aspect of the disclosure, the method includes sorting the plurality N of independent random samples into bins indexed by nonspherical directions of the multivariate generalized hyperbolic distribution and by the direction of a spherically transformed portfolio.

According to a further aspect of the disclosure, sampling a plurality N of independent d-dimensional vectors from a multivariate normal distribution N(0, Σ) includes computing a Cholesky decomposition A of Σ, simulating N independent random varieties z=(z₁, . . . , z_{d})′ from N(I_{d}, 0), where I_{d} is a d-dimensional identity matrix, and generating a Gaussian sample from X:=μ+Az, where μ is a sample mean.

According to another aspect of the disclosure, there is provided a non-transitory program storage device readable by a computer, tangibly embodying a program of instructions executed by the computer to perform the method steps for forecasting losses in a financial portfolio.

### BRIEF DESCRIPTION OF THE DRAWINGS

FIG. 1 is a flowchart of an algorithm for an expectation-maximization (EM) estimation of an ARMA-GARCH log-likelihood, for the case of a univariate generalized hyperbolic innovations, according to an embodiment of the disclosure.

FIG. 2 is a flowchart of a method for to producing a portfolio risk forecast from parameters of a copula dependence structure for the standardized residuals of each ARMA-GARCH model and parameters for the ARMA-GARCH models for each individual asset, according to an embodiment of the disclosure.

FIG. 3 is a table of ARMA-GARCH timing results for two exemplary computer systems, according to an embodiment of the disclosure.

FIG. 4 is a table that shows the scaling of the computational times used to estimate the covariance matrix Σ with respect to increasing the number of stocks, according to an embodiment of the disclosure.

FIG. 5 is a flowchart of a method for sampling a multivariate Gaussian, according to an embodiment of the disclosure.

FIG. 6 is a flowchart of a method for sampling from a multivariate generalized hyperbolic distribution, according to an embodiment of the disclosure.

FIG. 7 is a flowchart of a method for calculating parameters for a Student's t copula, according to an embodiment of the disclosure.

FIG. 8 is a table of timings for Cholesky factorizations, according to an embodiment of the disclosure.

FIG. 9 is a flowchart of a parallel Monte Carlo method of computing VaR_{α}, according to an embodiment of the disclosure.

FIG. 10 is a table of timing studies for the VaR calculation, both with a look up table and by a Monte Carlo method, according to an embodiment of the disclosure.

FIG. 11 is a table of back-testing results, according to an embodiment of the disclosure.

FIG. 12 is a table of overall timing studies according to embodiments of the disclosure.

FIG. 13 is a block diagram of an exemplary computer system for implementing a method for real-time forecasting the VaR of portfolios using multivariate heavy tailed stochastic models based on elliptical modeling of financial returns according to an embodiment of the disclosure.

### DETAILED DESCRIPTION OF EXEMPLARY EMBODIMENTS

Exemplary embodiments of the disclosure as described herein generally include systems and methods for real-time risk forecasting for portfolios with a large number of assets through explicit multivariate models. Accordingly, while the disclosure is susceptible to various modifications and alternative forms, specific embodiments thereof are shown by way of example in the drawings and will herein be described in detail. It should be understood, however, that there is no intent to limit the disclosure to the particular forms disclosed, but on the contrary, the disclosure is to cover all modifications, equivalents, and alternatives falling within the spirit and scope of the disclosure.

Systems and methods according to embodiments of the disclosure for estimating and forecasting with copula ARMA-GARCH models include:

(1) A new parallel ARMA-GARCH estimation algorithm that runs much faster than existing serial methods when benchmarked on parallel computational hardware;

(2) New parallel algorithms for the estimation of the generalized hyperbolic sub-Gaussian copula dependency structures;

(3) A new method for computing the VaR of an estimated copula ARMA-GARCH model without recourse to Monte Carlo methods of distributions applicable to a class of nearly elliptic distributions that is both faster and more memory efficient than existing Monte Carlo based methods;

(4) A parallel Monte Carlo method for offline construction of tables; and

(5) A parallel Monte Carlo method for evaluation of distributions which are not nearly elliptic or which are nearly elliptic, but whose subspace of exceptional dimensions is not low.

In addition, systems and methods according to embodiments of the disclosure for real time forecasting of risk metrics such as VaR for vary large portfolios include three components, all of which are faster and more memory efficient than their counterparts in existing methods. The end result is a system applicable to portfolios of over one hundred thousand assets, and with approximations in the diagonalization using factor analysis, to over a million assets, and which allows improved optimization of large portfolios.

A first component according to embodiments of the disclosure can estimate ARMA-GARCH models for each individual asset with a new parallel maximum likelihood estimation algorithm. Empirical scaling studies are provided of the run time of these algorithms according to embodiments of the disclosure relative to the number of assets, and includes generalized hyperbolic and Student's t ARMA-GARCH innovations, both of which allow for the commonly observed heavy tails. For comparison purposes, timing of ARMA-GARCH models with Gaussian innovations is also presented.

A second component according to embodiments of the disclosure are parallel algorithms for the estimation of the parameters of a copula dependence structure for the standardized residuals of each ARMA-GARCH model, including an algorithm for copulas of the Student's t distribution and for a generalized hyperbolic copula. Empirical scaling studies are provided for the run times with regard to the number of assets. Run times of Gaussian parameter estimation are also shown for comparison. There is ample empirical evidence that the heavy tailed distributions provide significant improvement over the more commonly used multivariate Gaussian distribution, which suffers from the assumption of asymptotically independent tail events.

A third component according to embodiments of the disclosure uses the output of the first two components to produce a portfolio risk forecast. Commonly used Gaussian methods suffer from a lack of heavy tails and resulting inaccuracies. All existing heavy tailed methods use Monte Carlo sampling for this step, where a large (more than 10,000) number of samples are drawn from the estimated copula and then filtered through each asset's ARMA-GARCH model. Due to the large number of samples required, the memory usage of the Monte Carlo algorithms is very high, especially when the number of assets in the portfolio is large. In addition, there is a large computational burden associated with forecasting a portfolio return for each individual copula sample. A system according to an embodiment of the disclosure provides a new method that does not require Monte Carlo sampling and instead uses numerical integration and density function tabulation to compute tail risk metrics explicitly via spherical transformations.

An algorithm according to embodiments of the disclosure may include the following steps.
1. Statistical data assimilation of historical raw data, using ARMA-GARCH. In this framework, the innovation process is the part of the data not predicted from the past, and is modeled with heavy tailed (non-Gaussian) processes.
2. Dependency parameter identification, illustrated with explicit formulas for two classes of models, generalized hyperbolic and student t, using data from step 1.
3. Monte Carlo construction of the joint distribution of returns for the next prediction period, based on steps 1-2.
4. Encapsulate the data from step 3 into a table for rapid retrieval.
5. Prediction of VaR, or other useful attributes for portfolio management, based on step 4.
   Embodiments of the disclosure may also include back testing, which include empirical studies that compare the historical performance of these methods according to embodiments of the disclosure against existing methods using the methodology established in the Basel III accords.

Asymptotic scaling of the above steps in the number d of stocks can be theoretically estimated as follows:

1. GARCH parameters: O(d).

2. Copula process parameters: O(d²).

3. Cholesky decomposition of the dispersion matrix Σ=AA^{T}: O(d³).

4. Monte Carlo (off line) and Table construction (off line): O(d³)

5. VaR from Table: O(d²).

6. Back testing (off line): O(d²).

These steps can be efficiently performed using parallel algorithms according to embodiments of the disclosure. Of these, the Monte Carlo step is the most time consuming asymptotically for large systems. In an approach according to embodiments of the disclosure, the Monte Carlo analysis is performed once only (off line) and is not part of the daily (or hourly) computation of VaR. Of the remaining steps, the Cholesky decomposition step dominates the time for large numbers of stocks. Commonly used Gaussian methods do not require a Cholesky decomposition, with its d³ scaling, and for portfolios of size 1 million, the Gaussian methods are faster. For portfolios of size 100,000, a linearly scaling O(d) ARMA-GARCH estimation is dominant, and is common to all four statistical models. Gaussian, generalized hyperbolic and Student's t are similar in total speed.

According to embodiments of the disclosure, VaR can be computed based on tabulated data from step 4. For the sake of specificity, results for a portfolio constructed out of instruments in the New York Stock Exchange Composite Index (d=5019, with sufficient data for back testing) are presented, in addition to scaling studies for a portfolio drawn from a universe of d=100,000 stocks. Other portfolio management predictions that depend on the statistical asset return models follow similar patterns.

On the basis of this scaling analysis, one may estimate time and hardware costs to compute a VaR. Because the expensive O(d³) step is needed only for the heavy tailed methods according to embodiments of the disclosure, Gaussian cost estimates are lower for large portfolio sizes (100,000 and 1 million, as considered here). Likewise, computational cost is dominated by step 3, for which well established estimates are available. There is considerable latitude for tradeoffs among portfolio size, speed of analysis and cost of hardware, which can be illustrated with a few examples. For a cost of a few thousand dollars, Nvidia hardware can compute VaR for 100,000 assets in about 15 minutes. The Titan supercomputer, located at Oak Ridge National Laboratory is estimated to calculate a VaR for 4 million assets in about 30 minutes. Doubling the number of assets increases the time (or the required machine speed) by a factor of 8. Another way to illustrate the analysis speed is to assume a computer rated at a teraflop or a petaflop per second in speed. A petaflop computer can analyze a Cholesky decomposition for one million assets in about 5 minutes, and 100,000 assets in about 0.3 seconds. A teraflop computer, such as a mid-sized Linux cluster or a small GPU cluster, can analyze a Cholesky decomposition in about 2 minutes and VaR for 100,000 assets in about 6 minutes. These Cholesky decomposition timings approximate the total computational time and cost tradeoff.

### 1. ARMA-GARCH Structures

Autoregressive conditional heteroscedastic (ARCH) models and their extensions to generalized ARCH (GARCH) models capture two features of financial returns: volatility clustering and excess leptokurtosis. In addition, an autoregressive moving average (ARMA) structure accounts for serial correlation. The standard Gaussian ARMA(p,q)-GARCH(r,s) model describes a return rᵢ as expressed in EQS. (1), which express the return at time t as a linear combination of earlier returns and innovations, and the variance at time t as a linear combination of earlier variances and innovations:

rₜ=c+Σᵢ₌₁^{p}aᵢrₜ₋ᵢ+Σⱼ₌₁^{q}bⱼεₜ₋ⱼ+εₜ,

σₜ²=ω+Σᵢ₌₁^{r}ρᵢεₜ₋ᵢ²+Σⱼ₌₁^{s}φⱼσₜ₋ᵢ²

εₜ=σₜuₜ (1)

with a conditional constant mean c∈R, a conditional variance ω≧0, ρᵢ≧0, and φᵢ≧0. The εₜ are referred to as innovations, with the standardized residuals uₜ having mean E[u]=0, and variance var[u]=1. The σₜ² are referred to as conditional variances. Additional constraints on aᵢ, bᵢ, ρᵢ, and φᵢ are applied to ensure stationarity (invariance under time translation) of the conditional mean and the conditional variance processes.

Empirical work has cast doubt upon the original assumption that uₜ˜N(0,1), the unit Gaussian, as these residuals often have significant excess kurtosis and skewness. According to embodiments of the disclosure, two innovation distributions are considered, which allow for heavy tails and asymmetry: generalized hyperbolic and Student's t.

A random variable Y is infinitely divisible if for each positive integer 11, there are independent and identically distributed random variables Y₁, Y₂, . . . , Yₙ, such that Y=Σₖ₌₁ⁿYₖ; that is, the distribution of Y is the same as the distribution of Σₖ₌₁ⁿYₖ. According to embodiments of the disclosure, the processes considered herein in explicit examples are infinitely divisible.

### 1.1 Generalized Hyperbolic Innovations

Definition.

A random vector X is said to have a (multivariate) normal mean-variance mixture distribution if

X=m(W)+\sqrt{W}AZ,

where
(i) Z˜Nₖ(0,Iₖ);
(ii) W is a non-negative, scalar-valued random variable which is independent of Z;
(iii) A∈R^{d×k} is a matrix; and
(iv) m:[0,∞)→R^{d} is a measurable function.
   A generalized hyperbolic distribution is obtained by letting m(W)=μ+Wγ, where μ and γ may be determined by reference to the data that the distribution is trying to model, and W˜N⁻(λ,χ,ψ), a Generalized Inverse Gaussian (GIG) distribution with density

$$f ( x ) = \frac{{{χ}^{- λ} ( \sqrt{χψ} )}^{λ}}{2 {K}_{λ} ( \sqrt{χψ} )} {x}^{λ - 1} exp ( - \frac{1}{2} ( χ {x}^{- 1} + ψ x ) ) , x > 0 ,$$

where K_{λ} denotes a modified Bessel function of the third kind with index λ. The parameters satisfy χ>0, ψ≧0 if λ<0, χ≧0, ψ>0 if λ>0, and χ>0, ψ>0 if λ=0. The standardized residuals uₜ in EQS. (1) may be sampled from this distribution.

Embodiments adopt the notation X˜GH_{d}(λ, χ, ψ, μ, Σ, γ). A joint density in the non-singular case (Σ has rank d) is

$$f ( x ) = c \frac{{K}_{λ - ( d / 2 )} ( \sqrt{( χ + {( x - μ )}^{′} {Σ}^{- 1} ( x - μ ) ) ( ψ + {γ}^{′} {Σ}^{- 1} γ )} ) {e}^{{( x - μ )}^{′} {Σ}^{- 1} γ}}{{( \sqrt{( χ + {( x - μ )}^{′} {Σ}^{- 1} ( x - μ ) ) ( ψ + {γ}^{′} {Σ}^{- 1} γ )} )}^{( d / 2 ) - λ}} ,$$

where the normalizing constant is

$$c = \frac{{( \sqrt{χψ} )}^{- λ} {{ψ}^{λ} ( ψ + {γ}^{′} {Σ}^{- 1} γ )}^{( d / 2 ) - λ}}{{( 2 π )}^{d / 2} {\vert \sum \vert}^{1 / 2} {K}_{λ} ( \sqrt{χψ} )} .$$

To obtain a univariate distribution, set d=1 and replace the covariance Σ with the scalar σ. To define the GH ARMA-GARCH normalized innovation, set σ=1 and u˜X˜GH_{I}(λ, χ, ψ, 0, 1, γ).

The Student's t distribution is the limiting case of a GH distribution, with ψ=0, λ=v/2, and χ=v. It has a parameter γ∈R, a location parameter μ∈R, a degrees of freedom parameter v>4, and a scale parameter σ>0. Its density function is given by EQ (2):

$$f ( x ) = c \frac{{K}_{\frac{v + d}{2}} ( \sqrt{( v + {( x - μ )}^{′} {σ}^{- 1} ( x - μ ) ) {γ}^{′} {σ}^{- 1} γ} ) exp ( {( x - μ )}^{′} {σ}^{- 1} γ )}{\begin{matrix}{( \sqrt{( v + {( x - μ )}^{′} {σ}^{- 1} ( x - μ ) ) {γ}^{′} {σ}^{- 1} γ} )}^{- \frac{v + d}{2}} \\ {( 1 + \frac{{( x - μ )}^{′} {σ}^{- 1} ( x - μ )}{v} )}^{\frac{v + d}{2}}\end{matrix}} , \qquad ( 2 )$$

where Kₐ is a modified Bessel function of the third kind and the normalizing constant is

$$c = \frac{{2}^{\frac{2 - ( v + d )}{2}}}{Γ ( \frac{v}{2} ) {( π v )}^{\frac{d}{2}} {σ}^{\frac{1}{2}}} .$$

A random variable X having the Student's t distribution may be denoted as X˜t(γ, μ, v, σ). To define a Student's t ARMA GARCH model, one may choose the Student's t normalized innovation u˜t(γ, 0, v, 1).

### 1.2 Gaussian Innovations

A random variable X is said to have a univariate Gaussian distribution with two parameters (μ, σ), denoted by X˜N(μ, σ²), if the density function is given by

$$f ( x ) = \frac{1}{σ \sqrt{2 π}} {e}^{- \frac{{( x - μ )}^{2}}{2 {σ}^{2}}} ,$$

where μ is the mean of Gaussian distribution, σ is the standard deviation, and σ² the variance.

A random vector X is said to have d-dimensional multivariate Gaussian distribution (non-degenerate case) if the joint density is given by

$$f ( x ) = \frac{1}{{( 2 π )}^{d / 2} {\vert \sum \vert}^{1 / 2}} exp ( - \frac{1}{2} {( x - μ )}^{′} {Σ}^{- 1} ( x - μ ) )$$

where d is the dimension, μ is the mean vector, and Σ is a symmetric positive definite matrix that represents the covariance matrix. A multivariate distributed random vector X may be denoted by X[N(μ, Σ) and the univariate Gaussian random variable as X˜N(μ, σ). Gaussian innovations are modeled as X˜N(0, σ).

If a random vector has a multivariate normal distribution, then any uncorrelated components are independent. In other words, the covariance matrix Σ entirely determines the dependence of the components.

### 1.3 Estimation Via Maximum Likelihood

A log-likelihood of an ARMA-GARCH model according to an embodiment of the disclosure as expressed by EQS. (1) is given by EQ. (3):

$$l ( \vec{θ} \vert {u}_{1} , … , {u}_{T} ) = {\sum }_{t = 1}^{T} log ( \frac{f ( {u}_{t} \vert \vec{θ} )}{{σ}_{t}} )$$

where ƒ(x) is the probability density function of the distribution assumed for {uₜ}_{t=1, . . . , T} and \vec{θ} is the vector of parameters to be estimated.

The conditional variance and scale processes in EQS. (1) should be stationary, which may be enforced by the simple linear inequality constraint of EQ. (4):

Σᵢ₌₁^{r}ρᵢ+Σⱼ₌₁^{s}φⱼ, (4)

To reverse filter {uₜ}_{t=1, . . . , T} and {σₜ}_{t=1, . . . , T} and evaluate EQ. (4), values of μ₀ and σ₀ may be presampled to initialize the first max(p, q, r, s) values of the ARMA-GARCH recursion. These may be set to their unconditional expected values, as expressed by EQ (5):

$${σ}_{0} = \sqrt{\frac{ω}{1 - {\sum }_{i = 1}^{r} {ρ}_{i} - {\sum }_{j = 1}^{s} {φ}_{j}}} , {u}_{0} = {σ}_{0} . \qquad ( 5 )$$

The following summarizes the parameter vector and constraint set for each type of ARMA-GARCH model according to embodiments of the disclosure to be considered. The stationarity conditions and initial values for each type of ARMA-GARCH model are respectively given by EQS. (4) and (5).
1. GH: μₜ˜GH₁(λ, χ, ψ, μ, 1, γ),
   \vec{θ}=(c, a₁, . . . , aₚ, b₁, . . . , b_{q}, ρ₁, . . . , ρᵣ, φ₁, . . . , φₛ, λ, χ, ψ, γ),
   λ∈R; χ>0, ψ≧0 if λ<0; χ≧0, ψ>0 if λ>0; χ>0, ω>0 if λ=0.
2. Student t: uₜ(γ, μ, v, 1),
   \tilde{θ}=(c, a₁, . . . , aₚ, b₁, . . . , bₚ, ρ₁, . . . , ρᵣ, φ₁, . . . , φₛ, γ, μ, v),
   γ, μ∈R; v>4.
3. Gaussian: uₜ˜N(0, 1)
   \vec{θ}=(c, a₁, . . . , aₚ, b₁, . . . , b_{q}, ρ₁, . . . , ρᵣ, φ₁, . . . , φₛ, λ, χ, ψ, γ).

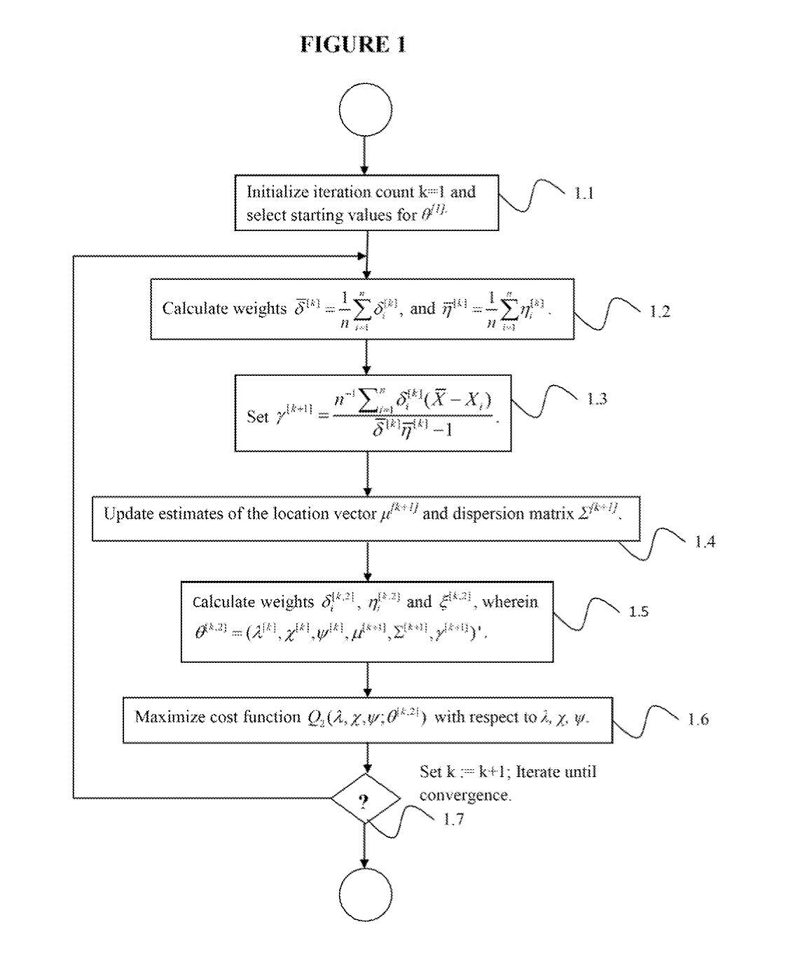

A detailed algorithm according to an embodiment of the disclosure for an expectation-maximization (EM) estimation of an ARMA-GARCH log-likelihood, for the case of a univariate generalized hyperbolic innovations is given below, with reference to the steps of the flowchart in FIG. 1.

1.1 Set the iteration count k=1 and select starting values for θ_{[1]}. In particular, set μ, γ, Σ to be the sample mean, zero vector and the sample variance, respectively.

1.2 Calculate weights δᵢ^{[k]} and ηᵢ^{[k]} using the following equations

δᵢ^{[k]}=E(Wᵢ⁻¹|Xᵢ;θ^{[k]}),

ηᵢ^{[k]}=E(Wᵢ|Xᵢ;θ^{[k]}).
Average the weights to get

$${\overline{δ}}^{[ k ]} = \frac{1}{n} {\sum }_{i = 1}^{n} {δ}_{i}^{[ k ]} , and {\overline{η}}^{[ k ]} = \frac{1}{n} {\sum }_{i = 1}^{n} {η}_{i}^{[ k ]} ,$$

where n is the sample size of the data used to fit the model.

1.3. For a symmetric model, set γ^{[k+1]}=0, otherwise set

$${γ}^{[ k + 1 ]} = \frac{{n}^{- 1} {\sum }_{i = 1}^{n} {δ}_{i}^{[ k ]} ( \overline{X} - {X}_{i} )}{{\overline{δ}}^{[ k ]} {\overline{η}}^{[ k ]} - 1} .$$

1.4. Update estimates of the location vector and dispersion matrix by

$${μ}^{[ k + 1 ]} = \frac{{n}^{- 1} {\sum }_{i = 1}^{n} {δ}_{i}^{[ k ]} {X}_{i} - {γ}^{[ k + 1 ]}}{{\overline{δ}}^{[ k ]}} , \\ Ψ = \frac{1}{n} {\sum }_{i = 1}^{n} {δ}_{i}^{[ k ]} ( {X}_{i} - {μ}^{[ k + 1 ]} ) {( {X}_{i} - {μ}^{[ k + 1 ]} )}^{′} - {\overline{η}}^{[ k ]} {γ}^{[ k + 1 ]} {γ}^{{[ k + 1 ]}^{′}} , \\ {Σ}^{[ k + 1 ]} = \frac{{\vert S \vert}^{1 / d} Ψ}{Ψ} ,$$

where S is a sample covariance defined as

$$S = \frac{1}{n} {\sum }_{i = 1}^{n} ( {X}_{i} - {μ}^{[ k + 1 ]} ) {( {X}_{i} - {μ}^{[ k + 1 ]} )}^{′} .$$

1.5. Set

θ^{[k,2]}=(λ^{[k]},χ^{[k]},ψ^{[k]},μ^{[k+1]},Σ^{[k+1]},γ^{[k+1]})′.
Calculate weights δᵢ^{[k,2]}, ηᵢ^{[k,2]} and ξ^{[k,2]} using the following equations

δᵢ^{[k,2]}=E(Wᵢ⁻¹|Xᵢ;θ^{[k,2]}),

ηᵢ^{[k,2]}=E(Wᵢ|Xᵢ;θ^{[k,2]}).

ξᵢ^{[k,2]}=E(ln(Wᵢ)|Xᵢ;θ^{[k,2]}).

1.6. Maximize Q₂(λ,χ,ψ;θ^{[k,2]}) with respect to λ, χ, ψ, where

$${Q}_{2} ( λ , χ , ψ , {θ}^{[ k , 2 ]} ) = ( λ - 1 ) {\sum }_{i = 1}^{n} {ξ}_{i}^{[ k , 2 ]} - \frac{1}{2} χ {\sum }_{i = 1}^{n} {δ}_{i}^{[ k , 2 ]} - \frac{1}{2} ψ {\sum }_{i = 1}^{n} {η}_{i}^{[ k , 2 ]} - \frac{1}{2} n λ ln ( χ ) + \frac{1}{2} n λln ( ψ ) - n ln ( 2 {K}_{λ} ( \sqrt{χψ} ) ) .$$

1.7. Set k→k+1 and go to step 1.2. Repeat until convergence.

According to embodiments of the disclosure, a sequential quadratic programming (SQP) algorithm may be used for a nonlinearly constrained gradient-based maximization. A stopping criteria according to an embodiment of the disclosure is a relative tolerance of 10⁻⁶ for all variables and an absolute tolerance of 10⁻⁶ for the log-likelihood objective function. The gradient of EQ. (4) may be computed with adaptive central finite differences using an initial step size of 10⁻⁶ for all parameters. An exemplary, non-limiting implementation according to an embodiment of the disclosure is in C++, however, other embodiments may use implementations in other computer languages.

### 1.4 Parallel Hardware

According to embodiments of the disclosure, two hardware platforms were considered for tests of parallel scaling: a modern single high performance workstation and a moderate sized Linux cluster. However, it is to be understood that these platforms are exemplary and non-limiting, and that other hardware platforms can be used by other embodiments of the disclosure.

1. A Linux cluster having 39 dual socket six-core, 64-bit Intel Xeon X5650 CPU @ 2.66 GHz. with 36 GB RAM per core, for a total of 39×12=468 cores.

2. A workstation with an 8 core 64-bit AMD FX-8150 CPU @3.6 GHz. with 16 GB RAM.

### 1.5 Parallel Estimation

A maximum likelihood (ML) estimation according to an embodiment of the disclosure of multiple ARMA-GARCH models for each asset in a large portfolio of d assets benefits from parallelization. An implementation according to an embodiment of the disclosure uses nodes in a master/slave layout, with several master processes distributing log-return data to many worker processes that perform the individual ML estimations. Since an ML estimation according to an embodiment of the disclosure for a given asset can proceed independently from that of other assets, only two types of inter-process communication are used:
The master processes may send T double precision log-returns to an idle worker process. There are d such messages that are passed, so the total size of all messages is 8×10×d bytes.
A worker process may send an estimated ARMA-GARCH parameter vector \hat{θ} of Section 1.3 back to a master process for later use. There are d such messages that are passed, so if a 10 parameter ARMA(1,1)-GARCH(1,1) model with t innovations is assumed for all N assets, the total message size is 8×10×d bytes.
   This gives a total message size of 8d(T+10), where typically d>T for large portfolios. Thus for a portfolio of d=5,000 assets, each described by an ARMA(1,1)-GARCH(1,1) model with t innovations estimated from 4 years of daily returns (T=1,000), the total amount of data that may be passed between processes is 38 megabytes. For d=1,000,000 assets, the total amount of data communicated is 7.5 gigabytes.

An exemplary, non-limiting implementation according to an embodiment of the disclosure uses the Message Passing Interface (MPI) for this type of communication and is written in C++. Note that the use of C++ is itself exemplary and non-limiting, and other computer languages could be used. To achieve scaling of the master-slave algorithm, the number of master processes may be increased while keeping fixed the master/slave ratio. Due to the parallel nature of the algorithm, the speedup is defined as:

$$Speed up = \frac{Wall time for 2 processes}{Wall time for p processes} ,$$

which increases linearly as the number of worker processes p increases.

Large data sets use multiple master processes to share the work, especially if the return data will not fit in the memory of a single node.

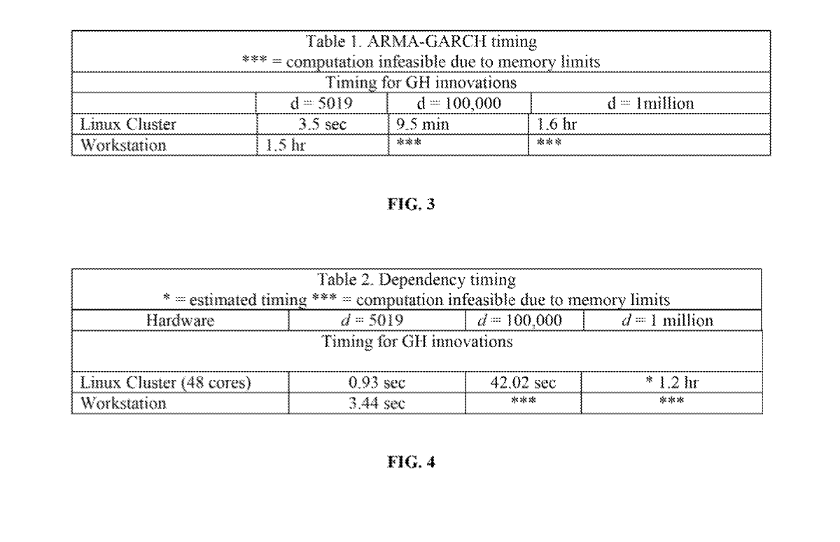

For two types of innovations distributions under consideration, the Student t and the Gaussian, ARMA(1,1)-GARCH(1,1) models according to embodiments of the disclosure can be estimated for each stock in a universe of N=5019 stocks with prices selected from the New York Stock Exchange Composite Index (NYSECI). Four years of daily log-returns computed from split and dividend adjusted closing prices are used for each estimation (T=1,000). These returns span the business days from Jan. 1, 2003 to Jan. 4, 2007. The choice of a four year daily look back window corresponds to the Basel III Accord recommendations for back testing. In additionally, algorithms according to embodiments of the disclosure are tested for 100,000 stocks using synthetic data from a resampled NYSECI. Other embodiments of the disclosure consider scaling the parallel ARMA-GARCH estimation with respect to the number of assets in the portfolio. The ARMA-GARCH timing results are presented in Table 1, shown in FIG. 3.

### 1.2 Dependence Structures for the Innovation Process

A first step of an algorithm according to an embodiment of the disclosure as presented in Section 1.1, with its linear scaling in the number d of assets, is not computationally demanding for large numbers of assets. The next two steps of an algorithm according to an embodiment of the disclosure, presented in Sections 1.2 and 1.3, estimate parameters of the multivariate processes, including the dispersion matrix E and its transformation into spherical coordinates. For these steps, parallelization is useful to estimate risk in real time for a large number of assets. According to an embodiment of the disclosure, a parallel estimation algorithm has been developed for this step, where each ML estimation for the elements of Σ is assigned to one of the available nodes for independent evaluation.

An algorithm according to an embodiment of the disclosure such as that presented in Sections 1.1 can estimate a univariate Student's t distributions for each marginal. An algorithm according to an embodiment of the disclosure can perform each of these estimations in parallel immediately after the ARMA-GARCH model for stock i is estimated.

Embodiments of the disclosure are here concerned with the multivariate coupling among the individual assets. A d-dimensional copula C is a d-dimensional density function on [0,1]^{d} with standard uniform margins. Sklar's Theorem states that every density function F with margins F₁, . . . , F_{d} can be expressed as EQ. (6):

F(x₁, . . . ,x_{d})=C(F₁(x₁), . . . ,F_{d}(x_{d})), (6)

for some unique copula function C having continuous margins. Continuity of the margins implies that there exist quantile functions Fᵢ⁻¹ for i=1, . . . , d, giving the joint copula density of EQ. (7):

C(u₁, . . . ,u_{d})=F(F₁⁻¹(u₁), . . . ,F_{d}⁻¹(u_{d})). (7)

Any process according to an embodiment of the disclosure considered herein and most others of practical importance can be transformed by an affine transform into a process with unit dispersion matrix I_{d} and null location vector \vec{μ}=0. Such a transformed process is said to be written in spherical coordinates. In general, the transformed process is not spherically symmetric. As an example, consider the following definition. The d-dimensional random vector \vec{X}=X₁, . . . , X_{d} is a normal mean-variance mixture if it has the stochastic representation of EQ. (8):

\vec{X}=\vec{μ}+\vec{γ}g(W)+\sqrt{W}\vec{Z}, (8)

for a function g:[0, ∞)→[0, ∞), a location vector it \vec{μ}∈R^{d}, a vector \vec{γ}∈R^{d}, and a dispersion matrix Σ∈R^{d×d}, with \vec{Z}˜N(0, Σ) and \vec{Z} independent of W. The transformation to spherical coordinates will replace the dispersion matrix Σ with the identity matrix and it will transform W. The independent process W, after transformation, introduces non spherically symmetric parameters into \vec{Z}.

If the nonspherically symmetric directions for a multivariate random process are confined to a finite dimensional subspace, the process may be said to be nearly spherical. The same terminology, before application of the affine transformation, yields the definitions of nearly elliptical if there are a finite number of non spherical dimensions, and elliptical if all dimensions are spherical after transformation.

Embodiments of the disclosure estimate the parameters of the multivariate generalized hyperbolic nearly elliptical distributions, that is, of the copulas, from historical data. The parameters include, but are not limited, to a dispersion matrix E, to be eliminated, i.e., replaced by a multivariate identity matrix by a transformation to spherical variables. Embodiments of the disclosure also generate scenarios for use with Monte Carlo simulations used to construct a table of the return value probability density function.

The estimation step is linear as the number of computing nodes increases. The d×d matrix estimation scales with d², i.e., linearly in the number of matrix elements. A power law according to an embodiment of the disclosure for estimation timing fitting to the observed data for the Student's t copula corresponds to:

Wall Time (sec)=1.2×10⁻⁶d^{1.935}.

Table 2, shown in FIG. 4, presents the scaling of the computational times used to estimate the covariance matrix E with respect to increasing the number of stocks.

### 1.2.1 Gaussian Copula

A Gaussian copula with dimension d may be defined as

C_{Σ}(\vec{u})=N_{Σ}^{d}(Φ⁻¹(u₁), . . . ,Φ⁻¹(u_{d}))

where Σ is a positive definite correlation matrix, and Φ⁻¹ represents the inverse distribution function of the univariate standard Gaussian distribution. This model is simple but lacks lower tail dependence.

### 1.2.2 Gaussian Copula Scenario Generation

A multivariate random vector with a standard normal marginal and a Gaussian copula of correlation matrix Σ is Gaussian, denoted N(0, Σ). A VaR for a Gaussian innovation with a Gaussian Copula model can be computed directly, without the use of a Cholesky decomposition, but a VaR for a hybrid model with GH innovations and a Gaussian copula depends on a table lookup and a Cholesky decomposition of the covariance matrix Σ.

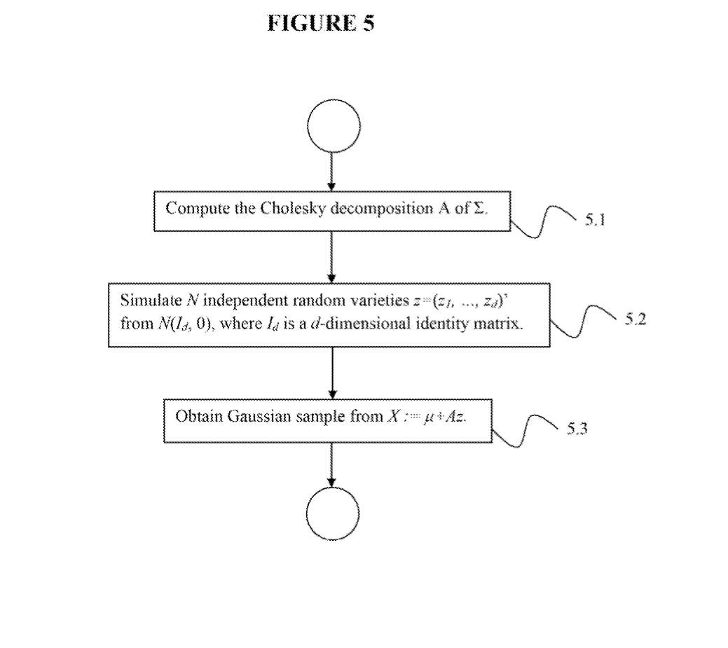

According to an embodiment of the disclosure, a multivariate Gaussian distribution may be sampled as follows, with reference to the flowchart of FIG. 5:

5.1. Compute the Cholesky decomposition A of Σ.

5.2. Simulate N independent random varieties z=(z₁, . . . , z_{d})′ from N(I_{d}, 0), where I_{d} is a d-dimensional identity matrix.

5.3. The Gaussian sample then can be obtained from X:=μ+Az.

### 1.2.3 The Multivariate Generalized Hyperbolic Copula

According to an embodiment of the disclosure, when g(W)=W in EQ. (8) and W has a generalized inverse Gaussian (GIG) distribution, X has a multivariate generalized hyperbolic (MGH) distribution. Its joint density function is given by

$$f ( x ) = c \frac{{K}_{λ - ( d / 2 )} ( \sqrt{( χ + {( x - μ )}^{′} {\sum }^{- 1} ( x - μ ) ) ( ψ + {γ}^{′} {\sum }^{- 1} γ )} ) {e}^{{( x - μ )}^{′} {\sum }^{- 1} γ}}{{( \sqrt{( χ + {( x - μ )}^{′} {\sum }^{- 1} ( x - μ ) ) ( ψ + {γ}^{′} {\sum }^{- 1} γ )} )}^{( d / 2 ) - λ}} ,$$

where the normalizing constant c is

$$c = \frac{{( \sqrt{χψ} )}^{- λ} {{ψ}^{λ} ( ψ + {γ}^{′} {\sum }^{- 1} γ )}^{( d / 2 ) - λ}}{{( 2 π )}^{d / 2} {\vert \sum \vert}^{1 / 2} {K}_{λ} ( \sqrt{χψ} )} .$$

The covariance of an MGH random vector X can be derived from a stochastic representation:

cov(X)=E(cov(X|W))+cov(E(X|W))=E(W)Σ+var(W)γγ′,

where

$$E ( W ) = ( \sqrt{\frac{χ}{ψ}} ) \frac{{K}_{λ + 1} ( \sqrt{χψ} )}{{K}_{λ} ( \sqrt{χψ} )} , \\ E ( {W}^{2} ) = ( \frac{χ}{ψ} ) \frac{{K}_{λ + 2} ( \sqrt{χψ} )}{{K}_{λ} ( \sqrt{χψ} )} , \\ and$$

$$var ( W ) = E ( {W}^{2} ) - {( E ( W ) )}^{2} .$$

According to an embodiment of the disclosure, the multivariate Student's t (MSST) distribution is a special case of the MGH distribution, obtained with W˜IG(v/2, v/2), where the inverse Gaussian (IG) distribution is a special limiting case of the GIG distribution. In contrast to the symmetric multivariate t distribution, the MSST allows for asymmetric tail dependence. Its density function is given by EQ. (9):

$$f ( \vec{X} ) = c \frac{{K}_{\frac{v + d}{2}} ( \begin{matrix}\sqrt{v + {( \vec{X} - \vec{μ} )}^{′} {\sum }^{- 1} ( \vec{X} - \vec{μ} ) ) {\vec{γ}}^{′} {\sum }^{- 1} \vec{γ}} \\ exp ( \vec{X} - \vec{μ} ) {\sum }^{- 1} \vec{γ}\end{matrix} )}{\begin{matrix}{( \sqrt{v + {( \vec{X} - \vec{μ} )}^{′} {\sum }^{- 1} ( \vec{X} - \vec{μ} ) ) {\vec{γ}}^{′} {\sum }^{- 1} \vec{γ}} )}^{- \frac{v + d}{2}} \\ {( 1 + \frac{{( \vec{X} - \vec{μ} )}^{′} {\sum }^{- 1} \vec{γ}}{v} )}^{\frac{v + d}{2}}\end{matrix}} \qquad ( 9 )$$

where Kₐ is a modified Bessel function of the third kind, and the normalizing constant c is

$$c = \frac{{2}^{\frac{2 - ( v + d )}{2}}}{Γ ( \frac{v}{2} ) {( π v )}^{d / 2} {\vert \sum \vert}^{1 / 2}} .$$

### 1.2.4 Generalized Hyperbolic Scenario Generation

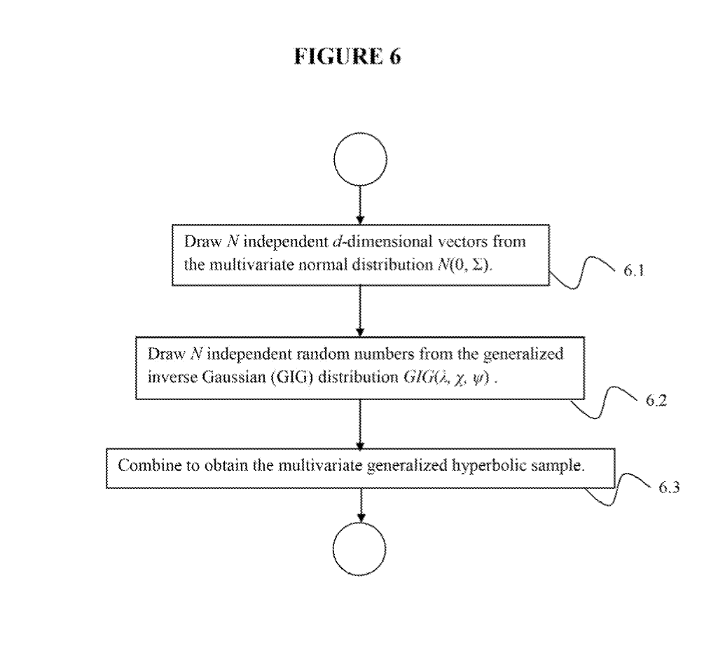

Sampling from the MGH distribution according to an embodiment of the disclosure can be accomplished by using a stochastic representation as presented in Section 1.1.1. According to an embodiment of the disclosure, N independent d-dimensional random vectors can be sampled from the MGH distribution as follows, with reference to the flowchart of FIG. 6:

6.1. Draw N independent d-dimensional vectors from the multivariate normal distribution N(0, Σ).

6.2. Draw N independent random numbers from the generalized inverse Gaussian (GIG) distribution G/G(λ, χ, ψ).

6.3. Combine these using Section 5.1.1 formulas to obtain the multivariate generalized hyperbolic sample.

Sampling from the MSST distribution according to an embodiment of the disclosure can also be accomplished by using a stochastic representation as presented in Section 1.1.1. According to an embodiment of the disclosure, N independent d-dimensional random vectors can be sampled from the MSST distribution as above for the MGH distribution, except for sampling from the inverse Gamma (IG) distribution IG(v/2, v/2) at step 6.2, instead of the generalized inverse Gaussian (GIG) distribution GIG(λ, χ, ψ). The combination at step 6.3 then yields the MSST sample.

### 1.2.5 Generalized Hyperbolic Parameter Estimation

A detailed algorithm according to an embodiment of the disclosure for an expectation-maximization (EM) estimation used to fit the multivariate generalized hyperbolic distribution is given below, again with reference to the steps of the flowchart in FIG. 1. Note that in this case the distributions are multivariate, not univariate.

1.1 Set the iteration count k=1 and select starting values for θ^{[1]}. In particular, set μ, γ, Σ to be the sample mean, zero vector and the sample variance, respectively.

1.2 Calculate weights δᵢ^{[k]} and ηᵢ^{[k]} using the following equations

δᵢ^{[k]}=E(Wᵢ⁻¹|Xᵢ;θ^{[k]}),

ηᵢ^{[k]}=E(Wᵢ|Xᵢ;θ^{[k]}).
Average the weights to get

$${\overline{δ}}^{[ k ]} = \frac{1}{n} {\sum }_{i = 1}^{n} {δ}_{i}^{[ k ]} , \\ and$$

$${\overline{η}}^{[ k ]} = \frac{1}{n} {\sum }_{i = 1}^{n} {η}_{i}^{[ k ]} .$$

1.3. For a symmetric model, set γ^{[k+1]}=0, otherwise set

$${γ}^{[ k + 1 ]} = \frac{{n}^{- 1} {\sum }_{i = 1}^{n} {δ}_{i}^{[ k ]} ( \overline{X} - {X}_{i} )}{{\overline{δ}}^{[ k ]} {\overline{η}}^{[ k ]} - 1} .$$

1.4. Update estimates of the location vector and dispersion matrix by

$${μ}^{[ k + 1 ]} = \frac{{n}^{- 1} {\sum }_{i = 1}^{n} {δ}_{i}^{[ k ]} {X}_{i} - {γ}^{[ k + 1 ]}}{{\overline{δ}}^{[ k ]}} , \\ Ψ = \frac{1}{n} {\sum }_{i = 1}^{n} {δ}_{i}^{[ k ]} ( {X}_{i} - {μ}^{[ k + 1 ]} ) {( {X}_{i} - {μ}^{[ k + 1 ]} )}^{′} - {\overline{η}}^{[ k + 1 ]} {γ}^{[ k + 1 ]} {γ}^{[ k + 1 ] ′} , \\ {\sum }^{[ k + 1 ]} = \frac{{\vert S \vert}^{1 / d} Ψ}{Ψ} .$$

1.5. Set

θ^{[k,2]}=(λ^{[k]},χ^{[k]},ψ^{[k]},μ^{[k+1]},Σ^{[k+1]},γ^{[k+1]})′.
Calculate weights δᵢ^{[k,2]}, ηᵢ^{[k,2]} and ξᵢ^{[k,2]} using the following equations

δᵢ^{[k,2]}=E*Wᵢ⁻¹|Xᵢ;θ^{[k,2]}),

ηᵢ^{[k,2]}=E(Wᵢ|Xᵢ;θ^{[k,2]}).

ξᵢ^{[k,2]}=E(ln(Wᵢ)|Xᵢ;θ^{[k,2]}).

1.6. Maximize Q₂(λ,χ,ψ;θ^{[k,2]}) with respect to λ, χ, ψ, where

$${Q}_{2} ( λ , χ , ψ ; {θ}^{[ \cdot ]} ) = ( λ - 1 ) {\sum }_{i = 1}^{n} {ξ}_{i}^{[ \cdot ]} - \frac{1}{2} χ {\sum }_{i = 1}^{n} {δ}_{i}^{[ \cdot ]} - \frac{1}{2} ψ {\sum }_{i = 1}^{n} {η}_{i}^{[ \cdot ]} - \frac{1}{2} n λln ( χ ) + \frac{1}{2} n λln ( ψ ) - n ln ( 2 {K}_{λ} ( \sqrt{χψ} ) ) .$$

1.7. Set k→k+1 and go to step 1.2. Repeat until convergence.

An EM algorithm according to an embodiment of the disclosure can also be used to set the parameters for the Student-t case. The degree of freedom v is updated in Step 1.6 by solving the following equation,

$$- φ ( \frac{v}{2} ) + log ( \frac{v}{2} ) + 1 - {\overline{ξ}}^{[ k ]} - {\overline{δ}}^{[ k ]} = 0 ,$$

where φ(•) is di-gamma function.

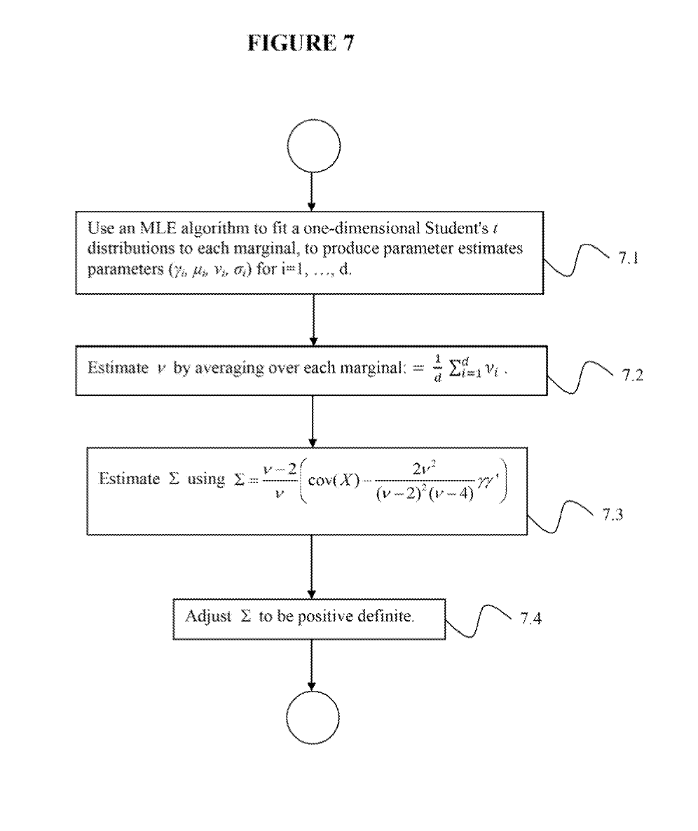

Finally, according to an embodiment of the disclosure, a simplification is given for the Student's t copula, with reference to the flowchart of FIG. 7.

7.1. Use an MLE algorithm according to an embodiment of the disclosure of Section 1.1.3 to fit a one-dimensional Student's t distributions to each marginal, producing parameter estimates parameters (γᵢ, μᵢ, vᵢ, σᵢ) for i=1, . . . , d.

7.2. Estimate v by averaging over each marginal:

$$v = \frac{1}{d} {\sum }_{i = 1}^{d} {v}_{i} .$$

An alternative would be to maximize the MSST profile log-likelihood with respect to v, holding all other parameters constant. However, this alternative approach has been found to be computationally challenging for d>500 due to the Bessel function in the explicit formulas.

7.3. Estimate Σ using

$$\sum = \frac{v - 2}{v} ( cov ( X ) - \frac{2 {v}^{2}}{{( v - 2 )}^{2} ( v - 4 )} {γγ}^{′} ) . \qquad ( 10 )$$

7.4. Adjust Σ to be positive definite.

### 1.3 VaR Computation Via Spherical Transformation

According to embodiments of the disclosure, financial returns can be transformed by an ARMA-GARCH method into a standard form. This affine transform amounts to translation by a constant (i.e., a non-random vector), and a multiplication by a scaling matrix. The standard models considered in embodiments of the disclosure come from a class of nearly elliptic models. Elliptic models are defined as having an affine to transformation to a spherical model. Spherical models are defined as being spherically symmetric. Nearly spherical models are spherically symmetric except for a finite dimensional subspace. Nearly elliptic models are those that transform into nearly spherical ones.

Elliptic (and nearly elliptic) models U are related to spherical (and nearly spherical) models Z through an affine transform:

U=AZ+μ

with the dispersion matrix Σ of U being factored as Σ=AA^{T}. A is called a Cholesky factor of Σ. Here Z is the spherical return vector, and U is a standard form (ARMA-GARCH transformed) return vector. Z has unit covariance and mean zero.

Methods according to embodiments of the disclosure make use of both the nearly elliptical nature of the processes and the small number of parameters in the exceptional non-spherical subspace. The processes considered in detail by embodiments of the disclosure have a one dimensional space of nonspherical directions. Most models of financial interest will fall within this limit, and those that do not can be addressed by parallel Monte Carlo methods according to embodiments of the disclosure.

In spherical coordinates, the client portfolio, which is a d-dimensional vector of weights w, transforms to an arbitrary direction, while the innovation process parameters also transform. For the Student's t case, there is one additional parameter, β. The transformed, or spherical return values then depend only on inner products of w with β and the associated magnitudes or norms. Thus a two parameter table will suffice.

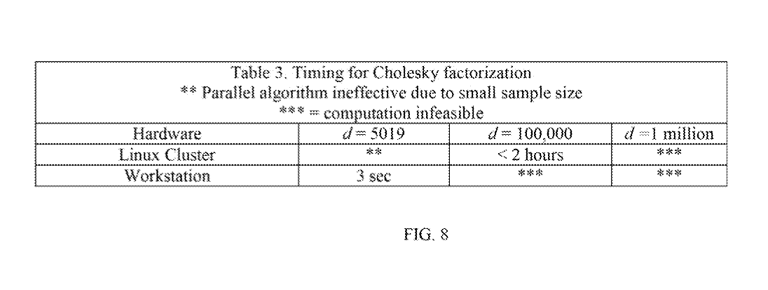

The Cholesky factorization is a well known algorithm in numerical linear algebra, with public domain parallelized codes. Theoretical scaling is based on an operation count of d³/3 floating point operations. Timings for this step is given in Table 3, shown in FIG. 8.

### 1.3.1 VaR Expressed in Spherical Variables

Let \vec{X}∈R^{d} and consider R^{d} as a Hilbert space with inner product [symbol] \vec{X}, \vec{Y} [symbol] =Σᵢ₌₁^{d}XᵢYᵢ and norm ∥\vec{X}∥= [symbol] In addition, consider random variables, denoted \tilde{X} with values in R^{d}. The vector \vec{w}∈R^{d} is used to represent portfolios, while the random variables \tilde{X} represent returns on the investment instruments, labeled as \vec{X}∈R^{d}. From the point of view of risk, losses are of interest, so that \tilde{X} is a random vector of losses or negative returns on the assets from which \vec{w} is drawn. With this terminology, the loss on the portfolio \vec{w} in a current time period is a random vector [symbol] \vec{w}, \tilde{X} [symbol] .

It may be assumed in an embodiment of the disclosure that the loss for the k-th asset \tilde{X} follows an ARMA-GARCH process according to an embodiment of the disclosure as described in Section 1.1. According to an embodiment of the disclosure, the modeling of the returns is transformed into the modeling of a standard innovation process, which differs from the returns by a translation and multiplication by a scaling matrix. The innovation process, which may be assumed in embodiments of the disclosure to be nearly elliptical, is transformed again into a nearly spherical process. The calculation of VaR may be performed on the nearly spherical process, and the results may be transformed back to actual portfolio returns.

These transformations imply that at time t there exist returns

$${r}_{t , k} = {c}_{k} + {\sum }_{i = 1}^{p} {a}_{i , k} {r}_{t - i , k} + {\sum }_{j = 1}^{q} {b}_{j , k} {ɛ}_{t - j , k} + {ɛ}_{tk}$$

$${σ}_{t , k}^{2} = {w}_{k} + {\sum }_{i = 1}^{p} {ρ}_{i , k} {σ}_{t - i , k}^{2} + {\sum }_{j = 1}^{s} {φ}_{j , k} {σ}_{t - j , k}^{2}$$

$${ɛ}_{t , k} = {σ}_{t , k} {u}_{t , k}$$

The VaR can be computed for the losses:

\tilde{X}_{T}=(r_{T,1}, . . . ,r_{T,d})

defined by the nearly elliptic random field standard form innovation vector u_{T}. Here u_{T}≡ũ_{T} and \tilde{X}_{T} are F_{T}-measurable, where F_{T} is the smallest σ-field generated by:

(r_{t,1}, . . . ,r_{t,d})′_{t=1, . . . ,s}

for all t≦T. Here a mention of randomness (tildes vs. arrows) refers to the current period (t=T) only. A portfolio loss distribution \tilde{Y}_{T} according to an embodiment of the disclosure can be denoted as a linear combination of financial instruments having random losses g, and portfolio defined weights \vec{w}∈R^{d}, as:

\tilde{Y}_{T}= [symbol] \vec{w}_{T-1},\tilde{X}_{T} [symbol] .

Then \tilde{Y}_{T} is F_{T} measurable, while \vec{w}≡\vec{w}_{T-1} is F_{T-1}-measurable, i.e., nonrandom relative to the current time period. According to an embodiment of the disclosure, a vector of normalized innovations Ũ_{T} may be defined by the formula:

\tilde{X}_{T}=\vec{μ}_{T-1}+D_{T-1}Ũ_{T},

where D_{T-1}Ũ=ε_{T} is the time T innovation, with D_{T-1}∈R^{d×d} and \vec{μ}_{T-1}∈R^{d} is the ARMA GARCH prediction. Both the diagonal scaling or normalization factors D_{T-1} and the ARMA GARCH predictions \vec{μ}_{T-1} are F_{T-1}-measurable, and thus not random at the current period. In an ARMA-GARCH model according to an embodiment of the disclosure as described above:

\vec{μ}_{T-1}=(μ_{1,T-1}, . . . ,μ_{d,T-1}),

\vec{μ}_{k,T-1}=cₖ+Σᵢ₌₁^{p}a_{i,k}r_{T-1,k}+Σⱼ₌₁^{q}b_{j,k}ε_{T-j,k}

and

$${D}_{T - 1} = ( \begin{matrix}{σ}_{T , 1} & 0 & … & 0 \\ 0 & {σ}_{T , 2} & 0 & ⋮ \\ ⋮ & ⋮ & ⋱ & ⋮ \\ 0 & 0 & … & {σ}_{T , d}\end{matrix} )$$

$$where$$

$${σ}_{T , k}^{2} = {ω}_{k} + {\sum }_{i = 1}^{p} {ρ}_{i , k} {ɛ}_{T - i , k}^{2} + {\sum }_{j = 1}^{s} {φ}_{j , k} {σ}_{T - j , k}^{2} ,$$

and σ_{T,k} is F_{T-1} measurable, i.e., not random relative to the current period (t=T). For brevity, the time dependence may be omitted in:

\tilde{X}=\vec{μ}_{T-1}+D_{T}Ũ_{T}=\vec{μ}_{T-1}+D_{T-1}A\tilde{Z}_{T}=\vec{μ}_{T-1}+B\tilde{Z}_{T}

in the transformation of the mean zero vector normalized process \check{U}_{T}=A\tilde{Z}_{T} to spherical variables, and use the short form as expressed in EQ. (11):

\tilde{X}≡\vec{μ}+B\check{Z}. (11)

According to an embodiment of the disclosure, it may be assumed that \tilde{Z} has one of the normal mean-variance mixture distributions discussed in Section 1, with B=D_{T-1}A∈R^{d×d}, \vec{μ}=\vec{μ}_{T-1}∈R^{d×d} and \tilde{Z} having a nearly spherical distribution.

Let \vec{w}ₛ=B^{T}\vec{w} be the spherically transformed portfolio \vec{w}, so that the spherical portfolio return is:

\tilde{Y}= [symbol] \vec{w},\tilde{X} [symbol] = [symbol] \vec{w},\vec{μ}+B\tilde{Z} [symbol] = [symbol] \vec{w},\vec{μ} [symbol] + [symbol] \vec{w}ₛ,\tilde{Z} [symbol] = [symbol] \vec{w},\vec{μ} [symbol] +\tilde{Y}ₛ

where \tilde{Y}ₛ is defined as \tilde{Y}ₛ=\tilde{Y}− [symbol] \vec{w},\vec{μ} [symbol] .

In terms of these spherically transformed variables, VaR at a confidence level a satisfies EQ. (12):

1−α=P(\tilde{Y}<VaR)=P(\tilde{Y}ₛ+ [symbol] \vec{w},\vec{μ} [symbol] <VaR)

1−α=P(\tilde{Y}ₛ<VaRₛ)=∫_{VaR}_{ₛ}^{∞}ƒ_{\check{Y}}_{ₛ}(y)dy (12)

where VaRₛ=VaR− [symbol] \vec{w}ₛ,\vec{μ} [symbol] has been defined as the spherical VaR and ƒ_{\tilde{Y}}_{ₛ} as the marginal of the probability with respect to the variable \tilde{Y}ₛ. According to an embodiment of the disclosure, with the function G as defined in EQ. (13):

G(VaRₛ)=∫_{VaR}_{ₛ}^{∞}ƒ_{\tilde{Y}}_{ₛ}(y)dy+α−1 (13)

the equation G=0 May be solved using bisection or secant methods to compute VaRₛ and VaR.

The exceptional (non-spherically symmetric) directions in the integration of EQ. (13) arise from \vec{w} and from the exceptional (non-spherically symmetric) directions in the measure defining \tilde{Z}ₛ. According to embodiments of the disclosure, formulas may be developed explicitly for the case of the Student's I distribution, for which there is a one dimensional space of non-spherical integration, or, in view of the role of \vec{w}ₛ, in total two exceptional dimensions. According to embodiments of the disclosure, this result may be generalized to other nearly elliptical cases.

According to an embodiment of the disclosure, the spherically transformed portfolio weight vector is given by \vec{w}ₛ=B^{T}\vec{w}. To compute EQ. (12), \tilde{Z} is first decomposed into components parallel and perpendicular to \vec{w}ₛ: \tilde{Z}=a₁\vec{e}₁+\tilde{Z}ᵢ^{⊥}, where

$${\vec{e}}_{1} = \frac{{\vec{w}}_{s}}{‖ {w}_{s} ‖}$$

and \tilde{Z}₁^{⊥} is the component of Z perpendicular to \vec{w}ₛ. According to an embodiment of the disclosure, fVaRₛ=VaRₛ/∥\vec{w}ₛ∥ may be defined as the RMS fractional VaRₛ and the explicit dependence of EQ. (12) on \vec{w}ₛ may be removed, as expressed in EQ. (14):

1−α=∫_{VaR}_{ₛ}^{∞}ƒ_{\tilde{Y}}_{ₛ}(∥\vec{w}ₛ∥a₁)d(∥\vec{w}ₛ∥a₁)=∫_{VaR}_{ₛ}^{∞}ƒ_{\tilde{Y}}(a₁)da₁ (14)

According to an embodiment of the disclosure, let ƒ_{\tilde{Z}} be the joint probability density function of the spherically transformed integration variable \tilde{Z}. ƒ_{\tilde{Y}}ₛ in EQ. (14) may be expressed as the marginal of ƒ_{\tilde{Z}}, as expressed in EQ. (15):

∫_{ƒVaR}_{ₛ}^{∞}ƒ_{\tilde{Y}}(a₁)da₁=∫_{ƒVaR}_{ₛ}^{∞}∫_{Z}_{₁}_{^{⊥}}ƒ_{\tilde{Z}(}\tilde{Z})d\tilde{Z}₁^{⊥}da₁ (15)

The transformed return values may depend on any additional parameters in the normal mean-variance mixture distribution assumed for \vec{X}, including the vector \vec{γ}. According to an embodiment of the disclosure, a generic parameter vector \vec{β} may be used to represent either V, a, or other parameters of other distribution not considered here. The spherically transformed version of this parameter is given by \hat{β}=A^{T}\vec{β}. \hat{β} may be decomposed into \hat{β}=b₁\vec{e}₁+\hat{β}₁^{⊥}, where b₁\vec{e}₁ is the component of \hat{β} parallel to \vec{w}ₛ, \hat{β}₁^{⊥} is the component of \hat{β} perpendicular to \vec{w}ₛ, and b₁= [symbol] \hat{β},\vec{e}₁ [symbol] . An additional decomposition of \tilde{Z}₁^{⊥}, which is already perpendicular to \vec{w}ₛ, into components parallel and perpendicular to \hat{β}₁^{⊥} yields \tilde{Z}₁^{⊥=a}₂\vec{e}₂+\tilde{Z}₂^{⊥} with

$${\vec{e}}_{2 w} = \frac{{\hat{β}}_{1}^{⊥}}{‖ {\hat{β}}_{1}^{⊥} ‖} .$$

Now EQ. (15) can be expressed as a triple integral

∫_{ƒVaR}_{ₛ}^{∞}∫_{Z}_{₁}_{^{⊥}}ƒ_{\check{Z}}(\tilde{Z})d\tilde{Z}₁^{⊥}da₁=∫_{ƒVaR}_{ₛ}^{∞}∫ₐ_{₂}∫_{Z}_{₁}_{^{⊥}}ƒ_{\check{Z}}(\tilde{Z})d\tilde{Z}₂^{⊥}da₂da₁

According to an embodiment of the disclosure, rewriting EQ (13) in terms of this new integral gives:

G(ƒVaRₛ)=∫_{ƒVaR}_{ₛ}^{∞}∫ₐ_{₂}∫_{Z}_{₁}_{^{⊥}}ƒ_{\check{Z}}(\tilde{Z})d\tilde{Z}₂^{⊥}da₂da₁+α−1=0,

which, when solved for fVaRₛ, gives the true VaR as:

VaR=∥\vec{w}ₛ∥ƒVaRₛ+ [symbol] \vec{w},\vec{u} [symbol] .

### 1.3.2 Timing for VaR Evaluation

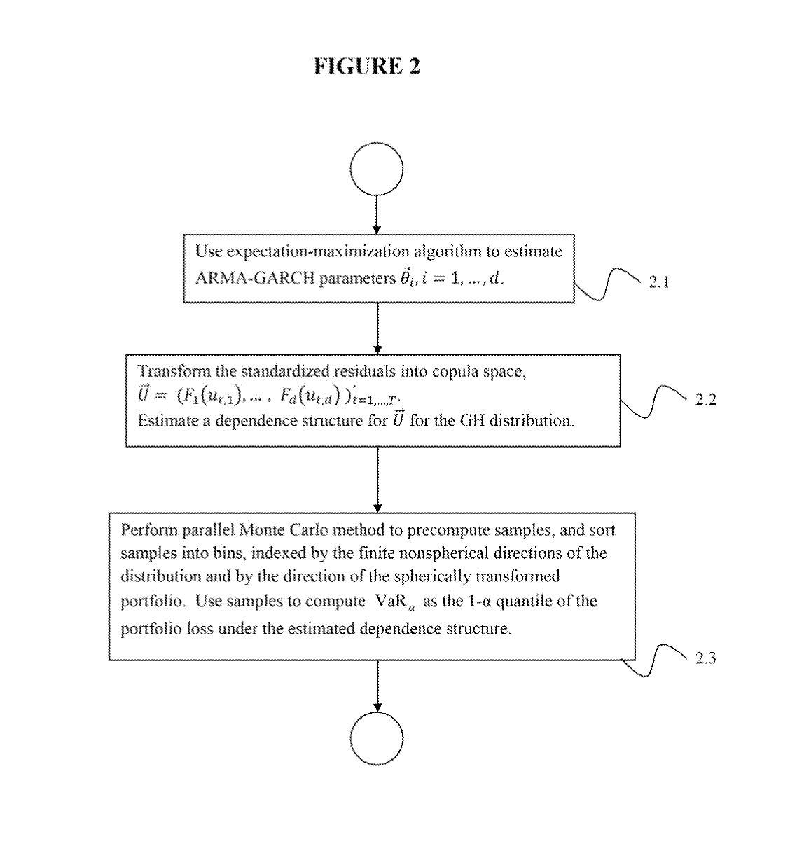

According to an embodiment of the disclosure, the copulas of Section 1.2 may be used to model dependencies between the standardized ARMA-GARCH residuals u_{t,d})_{t=1, . . . , T} for each asset i, i=1, . . . , d. An approach according to an embodiment of the disclosure allows consideration of multiple types of ARMA-GARCH innovation distributions under a single dependence structure. To forecast the risk of a portfolio for a next period, the following steps may be followed, with reference to step numbers of FIG. 2:
2.1. Use an algorithm according to an embodiment of the disclosure as presented in Section 1.1.3 to estimate ARMA-GARCH parameters \vec{θ}ᵢ, i=1, . . . , d.
2.2. Transform the standardized residuals into copula space,

\vec{U}=(F₁(u_{t,1}), . . . ,F_{d}(u_{t,d}))_{t=1, . . . ,T}′

where Fᵢ is the cumulative density function of the normalized innovation distribution. According to an embodiment of the disclosure, this step may be performed for asset i on the same computing node as that used to estimate θᵢ to benefit from a speed increase. Estimate a dependence structure for \vec{U} using EQ, (9) for the GH distribution.
2.3 According to embodiments of the disclosure, as a step in building a table, or in the case of an innovation distribution which is not nearly elliptical or which is nearly elliptical but whose finite dimensional exceptional subspace is not of low dimension, a parallel Monte Carlo method may be used, described next, with reference to the flowchart of FIG. 9.
   Compute VaR_{α} as the 1−α quantile of the portfolio loss under the estimated dependence structure. (9.1) Draw n=10,000 samples from the estimated dependence structure using algorithms according to embodiments of the disclosure as presented in Sections 1.2.2 and 1.2.5. (9.2) These samples can then be transformed into a copula space using the sample CDF Fₖ of the k-th marginal using EQ. (16).

$${F}_{k} ( x ) = \frac{1}{n} {\sum }_{j = - 1}^{n} {1}_{\{ {S}_{j , k \leq x} \}} \qquad ( 5.16 )$$

(9.3) \vec{X}ⱼ=(r_{t+1,1}, . . . , r_{t+1,d})_{j=1, . . . , n}′ may then be forecast for each stock using the estimated ARMA-GARCH coefficients \vec{θ}. (9.4) VaR may then be computed as the empirical 1−α quantile of all sampled portfolio returns ( [symbol] \vec{w},\vec{X}ⱼ [symbol] )_{j=1, . . . , n} for a given set of portfolio weights \vec{w}.

According to embodiments of the disclosure, for a typical case of a nearly elliptic distribution for the innovations, with a low dimensional subspace of exceptional (non-spherical) directions, samples may be precomputed as in step 2.3, above. The results can be sorted into bins, indexed by the finite nonspherical directions of the distribution and by the direction of the spherically transformed portfolio, which in view of the nearly spherical hypothesis, has an arbitrary direction outside of the finite dimensional space of exceptional directions.

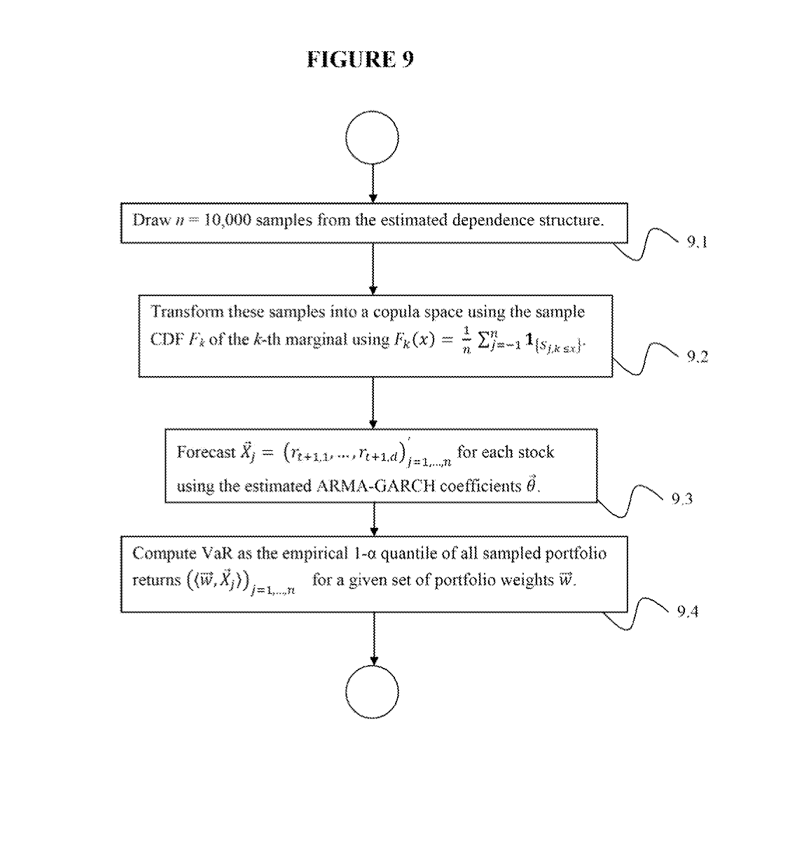

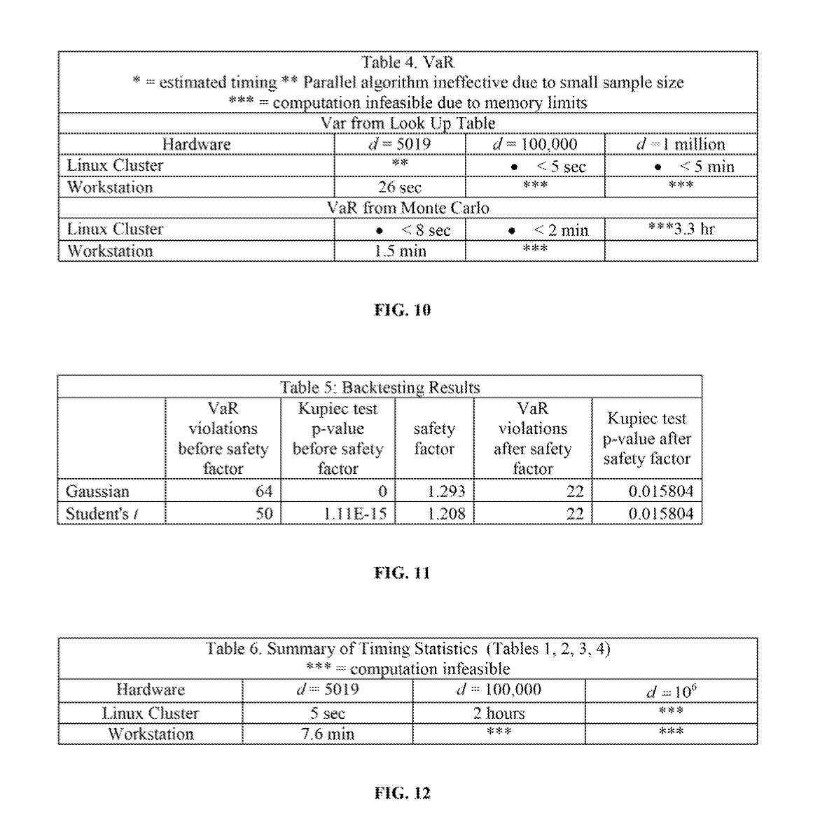

Timing studies for the VaR calculation, both with the look up table and by the Monte Carlo method, are presented in Table 4, shown in FIG. 10.

### 1.4 Back Testing

According to embodiments of the disclosure, three interval-based tests were performed to assess the quality of forecasted VaR_{0.01}. The first is a likelihood ratio test which tests the null hypothesis that each violation of VaRₚ occurs with probability p under the assumption of independence. Given the indicator sequence {Iₜ}_{t=1, . . . , T} of violations where:

Iₜ=1 if VaR_{p,t}≦rₜ₊₁,

Iₜ=0 if VaR_{p,t}>rₜ₊₁,

the test statistic is:

$${K}_{uc} = - 2 \frac{L ( p \vert {I}_{1} , … , {I}_{T} )}{L ( π \vert {I}_{1} , … , {I}_{T} )} \sim {χ}^{2}$$

According to an embodiment of the disclosure, π is the MLE estimator of E[I] assuming that I˜Binomial(T, π) with likelihood L.

This test of unconditional coverage (K_{uc}) may be extended to include two additional likelihood ratio tests: one for the null hypothesis that VaRₚ violations occur independently, irrespective of p(CLR_{ind}), and a second for the joint hypothesis of conditional coverage (CLR_{cc}), where violations occur independently with probability p.

According to embodiments of the disclosure, each model was backtested from Jan. 5, 2007 to Dec. 30, 2011 by forecasting one-day-ahead 99% VaR for each of the 1258 days. A test portfolio according to an embodiment of the disclosure assigns equal weights to each of the 5,109 equities in our portfolio. The criteria for inclusion of an equity in the test portfolio is that it is listed on either the AMEX, NASDAQ, or NYSE exchanges and have a price history spanning the full backtesting period. For equities listed on multiple exchanges, the exchange with the largest average daily volume was used for the equity in question.

The results are summarized in Table 5, shown in FIG. 11. All models pass the CLR_{ind} test at the 99% confidence level, so the p-values for this test are omitted for the table. The second column indicates that the Gaussian distribution has more VaR violations. However, neither of the models pass the K_{uc} test at 99% confidence without the addition of a safety factor. A safety factor multiples the VaR forecast of each day by a constant, and the minimum possible safety factor is selected that allows a given model to pass the K_{uc} test. The third column shows that the Gaussian model needs a larger safety factor.

### 1.5 Summary of Timing Studies

The overall timing studies according to embodiments of the disclosure are summarized in Table 6, shown in FIG. 12. A workstation may be sufficient for the analysis of 5019 assets, while a small Linux cluster is suitable for 100,000 assets and a small supercomputer is needed for 1 million assets.

The computer processor and algorithm for conducting aspects of the methods according to embodiments of the disclosure may be housed in devices that include desktop computers, scientific instruments, hand-held devices, personal digital assistants, phones, a non-transitory computer readable medium, and the like. Methods according to embodiments of the disclosure need not be carried out on a single processor. For example, one or more steps may be conducted on a first processor, while other steps are conducted on a second processor. The processors may be located in the same physical space or may be located distantly. In some such embodiments, multiple processors are linked over an electronic communications network, such as the Internet. Processors may be associated with a display device for showing the results of the methods to a user or users, outputting results as a video image and the processors may be directly or indirectly associated with information databases. As used herein, the terms processor, central processing unit, and CPU are used interchangeably and refer to a device that is able to read a program from a computer memory, e.g. ROM or other computer memory, and perform a set of steps according to the program. The terms computer memory and computer memory device refer to any storage media readable by a computer processor. Examples of computer memory include, but are not limited to, RAM, ROM, computer chips, digital video discs, compact discs, hard disk drives and magnetic tape. In addition, computer readable medium refers to any tangible device or system for storing and providing information, e.g., data and instructions, to a computer processor, DVDs, CDs, hard disk drives, magnetic tape and servers for streaming media over networks.

Exemplary embodiments as described herein may provide a system for forecasting portfolio risk in real time. Other embodiments may include extensions to other nearly elliptical distributions for innovations, and more general innovation distributions evaluated by Monte Carlo methods and may apply to other use of heavy tailed stochastic models, such as portfolio optimization.

It is to be further understood that, because some of the constituent system components and method steps depicted in the accompanying figures can be implemented in software, the actual connections between the systems components (or the process steps) may differ depending upon the manner in which the present disclosure is programmed. Given the teachings of the present disclosure provided herein, one of ordinary skill in the related art will be able to contemplate these and similar implementations or configurations of the present disclosure.

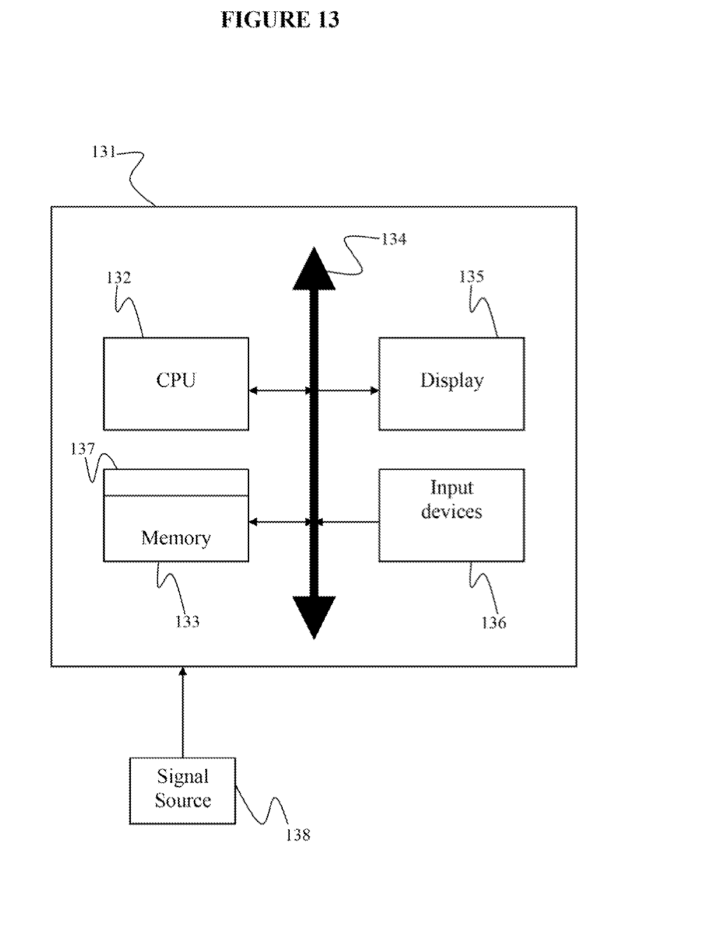

FIG. 13 is a block diagram of an exemplary computer system for implementing a method for real-time forecasting the VaR of portfolios using multivariate heavy tailed stochastic models based on elliptical modeling of financial returns according to an embodiment of the disclosure. Referring now to FIG. 13, a computer system 131 for implementing the present disclosure can comprise, inter alia, a central processing unit (CPU) 132, a memory 133 and an input/output (I/O) interface 134. The CPU 132 may be a multi-core CPU. The computer system 131 is generally coupled through the I/O interface 134 to a display 135 and various input devices 136 such as a mouse and a keyboard. The support circuits can include circuits such as cache, power supplies, clock circuits, and a communication bus. The memory 133 can include random access memory (RAM), read only memory (ROM), disk drive, tape drive, etc., or a combinations thereof. Embodiments of the present disclosure can be implemented as a routine 137 that is stored in memory 133 and executed by the CPU 132 to process the signal from the signal source 138. As such, the computer system 131 is a general purpose computer system that becomes a specific purpose computer system when executing the routine 137 of the present disclosure.

The computer system 131 also includes an operating system and micro instruction code. The various processes and functions described herein can either be part of the micro instruction code or part of the application program (or combination thereof) which is executed via the operating system. In addition, various other peripheral devices can be connected to the computer platform such as an additional data storage device and a printing device.

While embodiments of the present disclosure have been described in detail with reference to exemplary embodiments, those skilled in the art will appreciate that various modifications and substitutions can be made thereto without departing from the spirit and scope of the disclosure as set forth in the appended claims.

What is claims is:

1. A computer-implemented method for forecasting losses in a financial portfolio, comprising the steps of:
performing a maximum likelihood estimation of parameter values \vec{θ}=(c, a₁, . . . , aₚ, b₁, . . . , b_{q}, ρ₁, . . . , ρᵣ, φ₁, . . . , φₛ, λ, χ, ψ, γ) for a univariate generalized hyperbolic distribution for a random variable x given by
$$f ( x ) = c \frac{{K}_{λ - ( d / 2 )} ( \sqrt{( χ + {( x - μ )}^{′} {\sum }^{- 1} ( x - μ ) ) ( ψ + {γ}^{′} {\sum }^{- 1} γ )} ) {e}^{{( x - μ )}^{′} {\sum }^{- 1} γ}}{{( \sqrt{( χ + {( x - μ )}^{′} {\sum }^{- 1} ( x - μ ) ) ( ψ + {γ}^{′} {\sum }^{- 1} γ )} )}^{( d / 2 ) - λ}} ,$$
wherein K_{λ} denotes a modified Bessel function of the third kind with index λ, Σ is a covariance matrix, and c is a normalizing constant defined as
$$c = \frac{{( \sqrt{χψ} )}^{- λ} {{ψ}^{λ} ( ψ + {γ}^{′} {\sum }^{- 1} γ )}^{( d / 2 ) - λ}}{{( 2 π )}^{d / 2} {\vert \sum \vert}^{1 / 2} {K}_{λ} ( \sqrt{χψ} )} ,$$
wherein parameters c, a₁, . . . , aₚ, b₁, . . . , b_{q}, ρ₁, . . . , ρᵣ, φ₁, . . . , φₛ, are parameters of an ARMA(p,q)-GARCH(r,s) model that describes an asset return rᵢ, expressed as
rₜ=μ+Σᵢ₌₁^{p}aᵢrₜ₋₁+Σⱼ₌₁^{q}bⱼεₜ₋ⱼ+εₜ,
σₜ²=ω+Σᵢ₌₁^{r}ρᵢεₜ₋ᵢ²+Σⱼ₌₁^{s}φⱼσₜ₋ⱼ²
εₜ=σₜuₜ
wherein μ∈R is a conditional constant mean, ω≧0 is a conditional variance, ρᵢ≧0, φᵢ>0, εₜ are innovations with standardized residuals uₜ having mean E[u]=0, and variance var[u]=1, and σₜ² are conditional variances;
transforming the standardized residuals uₜ into copula space using
\vec{U}=(F₁(u_{t,1})), . . . ,F_{d}(u_{t,d}))_{t=1, . . . ,T}′
wherein Fᵢ is a cumulative density function of the normalized innovation distribution ƒ(x);
estimating a dependence structure for \vec{U}; and
calculating a portfolio risk forecast from the generalized hyperbolic distribution parameter values \vec{θ}=(c, a₁, . . . , aₚ, b₁, . . . , b_{q}, ρ₁, . . . , ρᵣ, φ₁, . . . , φₛ, λ, χ, ψ, γ) and parameters of the dependence structure.

2. The method of claim 1, wherein performing a maximum likelihood estimation of parameter values \vec{θ}=(c, a₁, . . . , aₚ, b₁, . . . , b_{q}, ρ₁, . . . , ρᵣ, φ₁, . . . , φₛ, λ, χ, ψ, γ) comprises solving
$$l ( \vec{θ} \vert {u}_{1} , … , {u}_{T} ) = {\sum }_{t = 1}^{T} log ( \frac{f ( {u}_{t} \vert \vec{θ} )}{{σ}_{t}} )$$
subject to a constraint that Σᵢ₌₁^{r}ρᵢ+Σⱼ₌₁^{s}φⱼ, wherein ƒ( ) is a probability density function of a distribution for {uₜ}_{t=1, . . . , T}, using a nonlinearly constrained gradient-based maximization with a stopping criteria being a relative tolerance of 10⁻⁶ for all variables and an absolute tolerance of 10⁻⁶ for the log-likelihood objective function.

3. The method of claim 2, wherein the nonlinearly constrained gradient-based maximization uses a sequential quadratic programming (SQP) algorithm, and wherein a gradient of the constraint may be computed with adaptive central finite differences using an initial step size of 10⁻⁶ for all parameters.

4. The method of claim 1, wherein performing a maximum likelihood estimation of parameter values \vec{θ}=(c, a₁, . . . , aₚ, b₁, . . . , b_{q}, ρ₁, . . . , ρᵣ, φ₁, . . . , φₛ, λ, χ, ψ, γ) for the univariate generalized hyperbolic distribution comprises:
initializing parameter values \vec{θ}^{[0]=(c, a}₁, . . . , aₚ, b₁, . . . , b_{q}, ρ₁, . . . , ρᵣ, φ₁, . . . , φₛ, λ, χ, ψ, γ) for the generalized hyperbolic distribution;
calculating weights
$${\overline{δ}}^{[ k ]} = \frac{1}{n} {\sum }_{i = 1}^{n} {δ}_{i}^{[ k ]} , \\ and$$
$${\overline{η}}^{[ k ]} = \frac{1}{n} {\sum }_{i = 1}^{n} {η}_{i}^{[ k ]}$$
wherein δᵢ^{[k]}=E(Wᵢ⁻¹|Xᵢ;θ^{[k]}) and ηᵢ^{[k]}=E(Wᵢ|Xᵢ;θ^{[k]}) for a random variable Xᵢ and a non-negative scalar random variable Wᵢ distributed as ƒ(x), wherein k is an iteration index;
updating parameter γ as
$${γ}^{[ k + 1 ]} = \frac{{n}^{- 1} {\sum }_{i = 1}^{n} {δ}_{i}^{[ k ]} ( \overline{X} - {X}_{i} )}{{\overline{δ}}^{[ k ]} {\overline{η}}^{[ k ]} - 1} ;$$
updating the mean μ and covariance matrix Σ as
$${μ}^{[ k + 1 ]} = \frac{{n}^{- 1} {\sum }_{i = 1}^{n} {δ}_{i}^{[ k ]} {X}_{i} - {γ}^{[ k + 1 ]}}{{\overline{δ}}^{[ k ]}}$$
$$and$$
$${\sum }^{[ k + 1 ]} = \frac{{\vert S \vert}^{1 / d} Ψ}{Ψ}$$
$$wherein$$
$$Ψ = \frac{1}{n} {\sum }_{i = 1}^{n} {δ}_{i}^{[ k ]} ( {X}_{i} - {μ}^{[ k + 1 ]} ) {( {X}_{i} - {μ}^{[ k + 1 ]} )}^{′} - {\overline{η}}^{[ k ]} {γ}^{[ k + 1 ]} {γ}^{[ k + 1 ] ′} ,$$
calculating weights δᵢ^{[k,2]}, ηᵢ^{[k,2]} and ξ^{[k,2]} from δᵢ^{[k,2]}=E(Wᵢ⁻¹|Xᵢ;θ^{[k,2]}), ηᵢ^{[k,2]}=E(Wᵢ|Xᵢ;θ^{[k,2]}), and ξᵢ^{[k,2]}=E(ln(Wᵢ)|Xᵢ;θ^{[k,2]}), wherein θ^{[k,2]}=(λ_{[k]}, χ^{[k]}, ψ^{[k]}, μ_{[k+1]}, Σ^{[k+1]}, γ^{[k+1]})′; and
determining values of parameters λ, χ, ψ that maximize
$$( λ - 1 ) {\sum }_{i = 1}^{n} {ξ}_{i}^{[ k , 2 ]} - \frac{1}{2} χ {\sum }_{i = 1}^{n} {δ}_{i}^{[ k , 2 ]} - \frac{1}{2} ψ {\sum }_{i = 1}^{n} {η}_{i}^{[ k , 2 ]} - \frac{1}{2} n λln ( χ ) + \frac{1}{2} n λln ( ψ ) - n ln ( 2 {K}_{λ} ( \sqrt{χψ} ) ) .$$

5. The method of claim 4, wherein γ^{[k+1]}=0 for a symmetric model.

6. The method of claim 4, wherein ψ=0, λ=v/2 with a degrees of freedom parameter v>4, and χ=v.

7. The method of claim 4, wherein said method is implemented on a computer having at least one multi-core processor, said cores are utilized in a master/slave layout wherein several master processes distribute data for W and X to many slave processes, wherein each slave received data for a single asset of said financial portfolio, and each slave process returns an estimate of the parameters \vec{θ}^{[k]}=(c, a₁, . . . , aₚ, b₁, . . . , b_{q}, ρ₁, . . . , ρᵣ, φ₁, . . . , φₛ, λ, χ, ψ, γ) to its master process.

8. The method of claim 1, wherein estimating parameter values \vec{θ}=(c, a₁, . . . , aₚ, b₁, . . . , b_{q}, ρ₁, . . . , ρᵣ, φ₁, . . . , φₛ, λ, χ, ψ, γ) of a copula dependence structure for the standardized residuals uₜ comprises:
initializing parameter values \vec{θ}^{[0]}=(c, a₁, . . . , aₚ, b₁, . . . , b_{q}, ρ₁, . . . , ρᵣ, φ₁, . . . , φₛ, λ, χ, ψ, γ) for a multivariate generalized hyperbolic distribution;
calculating weights
$${\overline{δ}}^{[ k ]} = \frac{1}{n} {\sum }_{i = 1}^{n} {δ}_{i}^{[ k ]} , \\ and$$
$${\overline{η}}^{[ k ]} = \frac{1}{n} {\sum }_{i = 1}^{n} {η}_{i}^{[ k ]}$$
wherein δᵢ^{[k]}=E(Wᵢ⁻¹|Xᵢ;θ^{[k]}) and ηᵢ^{[k]}=E(Wᵢ|Xᵢ;θ^{[k]}) for a non-negative scalar random variable Wᵢ distributed as ƒ(x), wherein k is an iteration index;
updating parameter γ as
$${γ}^{[ k + 1 ]} = \frac{{n}^{- 1} {\sum }_{i = 1}^{n} {δ}_{i}^{[ k ]} ( \overline{X} - {X}_{i} )}{{\overline{δ}}^{[ k ]} {\overline{η}}^{[ k ]} - 1} ;$$
updating the mean μ and covariance matrix Σ as
$${μ}^{[ k + 1 ]} = \frac{{n}^{- 1} {\sum }_{i = 1}^{n} {δ}_{i}^{[ k ]} {X}_{i} - {γ}^{[ k + 1 ]}}{{\overline{δ}}^{[ k ]}}$$
$$and$$
$${Σ}^{[ k + 1 ]} = \frac{{\vert S \vert}^{1 / d} Ψ}{Ψ}$$
$$wherein$$
$$Ψ = \frac{1}{n} {\sum }_{i = 1}^{n} {δ}_{i}^{[ k ]} ( {X}_{i} - {μ}^{[ k + 1 ]} ) {( {X}_{i} - {μ}^{[ k + 1 ]} )}^{′} - {\overline{η}}^{[ k ]} {γ}^{[ k + 1 ]} {{γ}^{[ k + 1 ]}}^{′} ,$$
calculating weights δᵢ^{[k,2]}, ηᵢ^{[k,2]} and ξ^{[k,2]} from δᵢ^{[k,2]}=E(Wᵢ⁻¹|Xᵢ;θ^{[k,2]}), ηᵢ^{[k,2]}=E(Wᵢ|Xᵢ;θ^{[k,2]}, and ξᵢ^{[k,2]}=E(ln(Wᵢ)|Xᵢ;θ^{[k,2]}), wherein θ^{[k,2]}=(λ^{[k]}, χ^{[k]}, ψ^{[k]}, μ^{[k+1]}, Σ^{[k+1]}, γ^{[k+1]})′; and
determining values of parameters λ, χ, ψ that maximize
$$( λ - 1 ) {\sum }_{i = 1}^{n} {ξ}_{i}^{[ k , 2 ]} - \frac{1}{2} χ {\sum }_{i = 1}^{n} {δ}_{i}^{[ k , 2 ]} - \frac{1}{2} ψ {\sum }_{i = 1}^{n} {η}_{i}^{[ k , 2 ]} - \frac{1}{2} n λ ln ( χ ) + \frac{1}{2} n λ ln ( ψ ) - n ln ( 2 {K}_{λ} ( \sqrt{χψ} ) ) .$$

9. The method of claim 8, wherein the univariate generalized hyperbolic distribution is a one-dimensional Student's t distribution wherein ψ=0, λ=v/2 with a degrees of freedom parameter v>4, and χ=v, and further comprising performing said maximum likelihood estimation for each univariate Student's t distribution to obtain parameters (γᵢ, μᵢ, vᵢ, σᵢ) for i=1, . . . , d wherein d is a number of dimensions, estimating v from
$$v = \frac{1}{d} {\sum }_{i = 1}^{d} {v}_{i} ,$$
estimating a covariance Σ from
$$Σ = \frac{v - 2}{v} ( cov ( X ) - \frac{2 {v}^{2}}{{( v - 2 )}^{2} ( v - 4 )} {γγ}^{′} )$$
wherein X is a random vector, and adjusting Σ to be positive definite.

10. The method of claim 1, wherein a dependence structure for \vec{U} is estimated from
$$f ( \vec{X} ) = c \frac{{K}_{\frac{v + d}{2}} ( \sqrt{v + {( \vec{X} - \vec{μ} )}^{′} {Σ}^{- 1} ( \vec{X} - \vec{μ} ) ) {\vec{γ}}^{′} {Σ}^{- 1} \vec{γ}} exp ( \vec{X} - \vec{μ} ) {Σ}^{- 1} \vec{γ} )}{\begin{matrix}{( \sqrt{( v + {( \vec{X} - \vec{μ} )}^{′} {Σ}^{- 1} ( \vec{X} - \vec{μ} ) ) {\vec{γ}}^{′} {Σ}^{- 1} \vec{γ}} )}^{- \frac{v + d}{2}} \\ {( 1 + \frac{{( \vec{X} - \vec{μ} )}^{′} {Σ}^{- 1} \vec{γ}}{v} )}^{\frac{v + d}{2}}\end{matrix}}$$
wherein Kₐ is a modified Bessel function of the third kind, and c is a normalizing constant defined as
$$c = \frac{{2}^{\frac{2 - ( v + d )}{2}}}{Γ ( \frac{v}{2} ) {( π v )}^{d / 2} {\vert Σ \vert}^{1 / 2}} .$$

11. The method of claim 1, wherein the ARMA-GARCH model has a nearly elliptical distribution, and calculating a portfolio risk forecast comprises:
drawing a plurality N of independent random samples from the dependence structure for \vec{U};
transforming these samples into copula space using a sample cumulative distribution function Fₖ of a k-th marginal using
$${F}_{k} ( x ) = \frac{1}{n} {\sum }_{j = - 1}^{n} {1}_{\{ {S}_{j , k \leq x} \}} ;$$
forecasting \vec{X}ⱼ=(rₜ₊₁, . . . , r_{t+1,d})_{j=1, . . . , n}′ for each asset using the estimated parameter values \vec{θ}; and
calculating a Value-at-Risk VaR from G(VaRₛ)=∫_{VaR}_{ₛ}^{∞}∫_{\tilde{Y}}_{ₛ}(y)dy+α−1 wherein α is a confidence level for the VaR, \tilde{Y}ₛ is defined as \tilde{Y}ₛ=\tilde{Y}− [symbol] \vec{w},\vec{μ} [symbol] wherein \tilde{Y}= [symbol] \vec{w},\tilde{X} [symbol] , \vec{w}∈R^{d} is a vector of portfolio weights, \tilde{X}_{T}=(r_{T,1}, . . . , r_{T,d}) is a vector of losses for d assets at time T, and \vec{μ} is defined by \tilde{X}_{T}=\vec{μ}_{T-1}+D_{T-1}Ũ_{T}, wherein D_{T-1}Ũ_{T}=ε_{T} is a time T innovation with D_{T-1}∈R^{d×d} and \vec{μ}_{T-1}∈R^{d} is an ARMA GARCH prediction, and ƒ_{\tilde{Y}}_{ₛ} is a marginal of a probability with respect to \tilde{Y}ₛ.

12. The method of claim 11, wherein drawing a plurality N of independent random samples from the dependence structure for \vec{U} comprises:
sampling a plurality N of independent d-dimensional vectors from a multivariate normal distribution N(0, Σ);
sampling a plurality N of independent random numbers from a Generalized inverse Gaussian distribution
$$f ( x ) = \frac{{{χ}^{- λ} ( \sqrt{χψ} )}^{λ}}{2 {K}_{λ} ( \sqrt{χψ} )} {x}^{λ - 1} exp ( - \frac{1}{2} ( χ {x}^{- 1} + ψ x ) ) ,$$
x>0; and
combining these samples to obtain a multivariate generalized hyperbolic sample.

13. The method of claim 12, further comprising sorting the plurality N of independent random samples into bins indexed by nonspherical directions of the multivariate generalized hyperbolic distribution and by the direction of a spherically transformed portfolio.

14. The method of claim 12, wherein sampling a plurality N of independent d-dimensional vectors from a multivariate normal distribution N(0, Σ) comprises:
computing a Cholesky decomposition A of Σ;
simulating N independent random varieties z=(z₁, . . . , z_{d})′ from N(I_{d}, 0), where I_{d} is a d-dimensional identity matrix; and
generating a Gaussian sample from X:=μ+Az, wherein μ is a sample mean.

15. The method of claim 1, wherein transforming the standardized residuals uₜ into copula space is performed for an asset on a same computer node as that used to estimate parameter values \vec{θ} for that asset.

16. A computer-implemented method for forecasting losses in a financial portfolio, comprising the steps of:
estimating parameters of an autoregressive-moving-average generalized-autoregressive-conditional-heteroscedastic (ARMA-GARCH) model for each individual asset in a financial portfolio by performing a parallel maximum likelihood estimation;
estimating parameters of a copula dependence structure for standardized residuals of said ARMA-GARCH model; and
estimating a Value-at-Risk (VaR) for said financial portfolio from said ARMA-GARCH model parameters and said copula dependence structure parameters.

17. The method of claim 16, wherein said ARMA-GARCH model is expressed as
rₜμ+Σᵢ₌₁^{p}aᵢrₜ₋ᵢ+Σⱼ₌₁^{q}bⱼεₜ₋ⱼ+εₜ,
σₜ²=ω+Σᵢ₌₁^{r}ρᵢεₜ₋ᵢ²+Σⱼ₌₁^{s}φⱼσₜ₋ⱼ²
εₜ=σₜuₜ
wherein μ∈R is a conditional constant mean, ω≧0 is a conditional variance, ρᵢ>0, φᵢ>0, εₜ are innovations with standardized residuals uₜ having mean E[u]=0, and variance var[u]=1, and σₜ² are conditional variances, and wherein c, a₁, . . . ,aₚ, b₁, . . . , b_{q}, ρ₁, . . . , ρᵣ, φ₁, . . . , φₛ, are the model parameters being estimated.

18. The method of claim 17, wherein the standardized residuals uₜ are sampled from a univariate generalized hyperbolic distribution for a random variable x given by
$$f ( x ) = c \frac{{K}_{λ - ( d / 2 )} ( \sqrt{( χ + {( x - μ )}^{′} {Σ}^{- 1} ( x - μ ) ) ( ψ + {γ}^{′} {Σ}^{- 1} γ )} ) {e}^{{( x - μ )}^{′} {Σ}^{- 1} γ}}{{( \sqrt{( χ + {( x - μ )}^{′} {Σ}^{- 1} ( x - μ ) ) ( ψ + {γ}^{′} {Σ}^{- 1} γ )} )}^{( d / 2 ) - λ}} ,$$
wherein K_{λ} denotes a modified Bessel function of the third kind with index λ, Σ is a covariance matrix, and c is a normalizing constant defined as
$$c = \frac{{( \sqrt{χψ} )}^{- λ} {{ψ}^{λ} ( ψ + {γ}^{′} {Σ}^{- 1} γ )}^{( d / 2 ) - λ}}{{( 2 π )}^{d / 2} {\vert Σ \vert}^{1 / 2} {K}_{λ} ( \sqrt{χψ} )} .$$

19. The method of claim 16, wherein performing a parallel maximum likelihood estimation comprises solving
$$l ( \vec{θ} \vert {u}_{1} , … , {u}_{T} ) = {\sum }_{ t = 1}^{T} log ( \frac{f ( {u}_{t} \vert \vec{θ} )}{{σ}_{t}} )$$
subject to a constraint that Σᵢ₌₁^{r}ρᵢ+Σⱼ₌₁^{s}φⱼ, wherein ƒ( ) is a probability density function of a distribution for {uₜ}_{t=1, . . . , T}, using a nonlinearly constrained gradient-based maximization.

20. The method of claim 17, wherein estimating parameters of a copula dependence structure for standardized residuals of said ARMA-GARCH model comprises transforming the standardized residuals uₜ into copula space using \vec{U}=(F₁(u_{t,1}), . . . , F_{d}(u_{t,d}))_{t=1, . . . , T}′ wherein Fᵢ is a cumulative density function of the normalized innovation distribution ƒ(x), and estimating a dependence structure for \vec{U} is estimated from a multivariate generalized hyperbolic distribution.

21. The method of claim 16, wherein the ARMA-GARCH model has a nearly elliptical distribution, and estimating said Value-at-Risk (VaR) for said financial portfolio comprises using uses numerical integration and density function tabulation to compute said VaR via a spherical transformation.

22. The method of claim 21, wherein estimating a Value-at-Risk (VaR) for said financial portfolio further comprises:
drawing a plurality N of independent random samples from the dependence structure for \vec{U};
transforming these samples into copula space using a sample cumulative distribution function Fₖ of a k-th marginal using
$${F}_{k} ( x ) = \frac{1}{n} {\sum }_{j = - 1}^{n} {1}_{\{ {S}_{j , k \leq x} \}} ;$$
forecasting \vec{X}ⱼ=(r_{t+1,1}, . . . , r_{t+1,d})_{j=1, . . . , n}′ for each asset using the estimated parameter values \vec{θ}; and
calculating a Value-at-Risk VaR from G(VaRₛ)=∫_{VaR}_{ₛ}^{∞}ƒ_{\tilde{Y}}_{ₛ}(y)dy+α−1 wherein α is a confidence level for the VaR, \tilde{Y}ₛ is defined as \tilde{Y}ₛ=\tilde{Y}− [symbol] \vec{w},\vec{μ} [symbol] wherein \tilde{Y}= [symbol] \vec{w},\tilde{X} [symbol] , \vec{w}∈R^{d} is a vector of portfolio weights, \tilde{X}_{T}=(r_{T,1}, . . . , r_{T,d}) is a vector of losses for d assets at time T, and \vec{μ} is defined by \tilde{X}_{T}=\vec{μ}_{T-1}+D_{T-1}Ũ_{T}, wherein D_{T-1}Ũ_{T}=ε_{T} is a time T innovation with D_{T-1}∈R^{d×d} and \vec{μ}_{T-1}∈R^{d} is an ARMA GARCH prediction, and ƒ_{\tilde{Y}}_{ₛ} is a marginal of a probability with respect to \tilde{Y}ₛ.

23. The method of claim 22, wherein drawing a plurality N of independent random samples from the dependence structure for \vec{U} comprises:
sampling a plurality N of independent d-dimensional vectors from a multivariate normal distribution N(0, Σ);
sampling a plurality N of independent random numbers from a Generalized inverse Gaussian distribution
$$f ( x ) = \frac{{{χ}^{- λ} ( \sqrt{χψ} )}^{λ}}{2 {K}_{λ} ( \sqrt{χψ} )} {x}^{λ - 1} exp ( - \frac{1}{2} ( χ {x}^{- 1} + ψ x ) ) ,$$
x>0; and
combining these samples to obtain a multivariate generalized hyperbolic sample.

24. The method of claim 23, further comprising sorting the plurality N of independent random samples into bins indexed by nonspherical directions of the multivariate generalized hyperbolic distribution and by the direction of a spherically transformed portfolio.

25. The method of claim 23, wherein sampling a plurality N of independent d-dimensional vectors from a multivariate normal distribution N(0, Σ) comprises:
computing a Cholesky decomposition A of Σ;
simulating N independent random varieties z=(z₁, . . . , z_{d})′ from N(I_{d}, 0), where I_{d} is a d-dimensional identity matrix; and
generating a Gaussian sample from X:=μ+Az, wherein μ is a sample mean.

26. A non-transitory program storage device readable by a computer, tangibly embodying a program of instructions executed by the computer to perform the method steps for forecasting losses in a financial portfolio, the method comprising the steps of:
performing a maximum likelihood estimation of parameter values \vec{θ}=(c, a₁, . . . , aₚ, b₁, . . . , b_{q}, ρ₁, . . . , ρᵣ, φ₁, . . . , φₛ, λ, χ, ψ, γ) for a univariate generalized hyperbolic distribution for a random variable x given by
$$f ( x ) = c \frac{{K}_{λ - ( d / 2 )} ( \sqrt{( χ + {( x - μ )}^{′} {Σ}^{- 1} ( x - μ ) ) ( ψ + {γ}^{′} {Σ}^{- 1} γ )} ) {e}^{{( x - μ )}^{′} {Σ}^{- 1} γ}}{{( \sqrt{( χ + {( x - μ )}^{′} {Σ}^{- 1} ( x - μ ) ) ( ψ + {γ}^{′} {Σ}^{- 1} γ )} )}^{( d / 2 ) - λ}} ,$$
wherein K_{λ} denotes a modified Bessel function of the third kind with index λ, Σ is a covariance matrix, and c is a normalizing constant defined as
$$c = \frac{{( \sqrt{χψ} )}^{- λ} {{ψ}^{λ} ( ψ + {γ}^{′} {Σ}^{- 1} γ )}^{( d / 2 ) - λ}}{{( 2 π )}^{d / 2} {\vert Σ \vert}^{1 / 2} {K}_{λ} ( \sqrt{χ ψ} )} ,$$
wherein parameters c, a₁, . . . , aₚ, b₁ . . . , b_{q}, ρ₁, . . . , ρᵣ, φ₁, . . . , φₛ, are parameters of an ARMA(p,q)-GARCH(r,s) model that describes an asset return rᵢ expressed as
rₜ=μ+Σᵢ₌₁^{p}aᵢrₜ₋ᵢ+Σⱼ₌₁^{q}bⱼεₜ₋ⱼ+εₜ,
σₜ²=ω+Σᵢ₌₁^{r}ρᵢεₜ₋ᵢ²+Σⱼ₌₁^{s}φⱼσₜ₋ᵢ²
εₜ=σₜuₜ
wherein ρ∈R is a conditional constant mean, ω≧0 is a conditional variance, ρᵢ>0, φᵢ>0, εₜ are innovations with standardized residuals uᵢ having mean E[u]=0, and variance var[u]=1, and σₜ² are conditional variances;
transforming the standardized residuals uₜ into copula space using
\vec{U}=(F₁(u_{t,1}), . . . ,F_{d}(u_{t,d}))_{t=1, . . . ,T}′
wherein Fᵢ is a cumulative density function of the normalized innovation distribution ƒ(x);
estimating a dependence structure for \vec{U}; and
calculating a portfolio risk forecast from the generalized hyperbolic distribution parameter values \vec{θ}=(c, a₁, . . . , aₚ, b₁, . . . , b_{q}, ρ₁, . . . , ρᵣ, φ₁, . . . , φₛ, λ, χ, ψ, γ) and parameters of the dependence structure.

27. The computer readable program storage device of claim 26, wherein performing a maximum likelihood estimation of parameter values \vec{θ}=(c, a₁, . . . , aₚ, b₁, . . . , b_{q}, ρ₁, . . . , ρᵣ, φ₁, . . . , φₛ, λ, χ, ψ, γ) comprises solving
$$l ( {θ}^{->} \vert {u}_{1} , … , {u}_{T} ) = {\sum }_{t = 1}^{T} log ( \frac{f ( {u}_{t} \vert {θ}^{->} )}{{σ}_{t}} )$$
subject to a constraint that Σᵢ₌₁^{r}ρᵢ+Σⱼ₌₁^{s}φⱼ, wherein ƒ( ) is a probability density function of a distribution for {uₜ}_{t=1, . . . , T}, using a nonlinearly constrained gradient-based maximization with a stopping criteria being a relative tolerance of 10⁻⁶ for all variables and an absolute tolerance of 10⁻⁶ for the log-likelihood objective function.

28. The computer readable program storage device of claim 27, wherein the nonlinearly constrained gradient-based maximization uses a sequential quadratic programming (SQP) algorithm, and wherein a gradient of the constraint may be computed with adaptive central finite differences using an initial step size of 10⁻⁶ for all parameters.

29. The computer readable program storage device of claim 26, wherein performing a maximum likelihood estimation of parameter values \vec{θ}=(c, a₁, . . . , aₚ, b₁, . . . , b_{q}, ρ₁, . . . , ρᵣ, φ₁, . . . , φₛ, λ, χ, ψ, γ) for the univariate generalized hyperbolic distribution comprises:
initializing parameter values \vec{θ}^{[0]}=(c, a₁, . . . , aₚ, b₁, . . . , b_{q}, ρ₁, . . . , ρᵣ, φ₁, . . . , φₛ, λ, χ, ψ, γ) for the generalized hyperbolic distribution;
calculating weights
$${\overline{δ}}^{[ k ]} = \frac{1}{n} {\sum }_{i = 1}^{n} {δ}_{i}^{[ k ]} , \\ and$$
$${\overline{η}}^{[ k ]} = \frac{1}{n} {\sum }_{i = 1}^{n} {η}_{i}^{[ k ]}$$
wherein δᵢ^{[k]}=E(Wᵢ⁻¹|Xᵢ;θ^{[k]}) and ηᵢ^{[k]}=E(Wᵢ|Xᵢ;θ^{[k]}) for a random variable Xᵢ and a non-negative scalar random variable Wᵢ distributed as ƒ(x), wherein k is an iteration index;
updating parameter γ as
$${γ}^{[ k + 1 ]} = \frac{{n}^{- 1} {\sum }_{i = 1}^{n} {δ}_{i}^{[ k ]} ( \overline{X} - {X}_{i} )}{{\overline{δ}}^{[ k ]} {\overline{η}}^{[ k ]} - 1} ;$$
updating the mean μ and covariance matrix Σ as
$${μ}^{[ k + 1 ]} = \frac{{n}^{- 1} {\sum }_{i = 1}^{n} {δ}_{i}^{[ k ]} {X}_{i} - {γ}^{[ k + 1 ]}}{{\overline{δ}}^{[ k ]}}$$
$$and$$
$${Σ}^{[ k + 1 ]} = \frac{{\vert S \vert}^{1 / d} Ψ}{Ψ}$$
$$wherein$$
$$Ψ = \frac{1}{n} {\sum }_{i = 1}^{n} {δ}_{i}^{[ k ]} ( {X}_{i} - {μ}^{[ k + 1 ]} ) {( {X}_{i} - {μ}^{[ k + 1 ]} )}^{′} - {\overline{η}}^{[ k ]} {γ}^{[ k + 1 ]} {γ}^{[ k + 1 ] ′} ,$$
calculating weights δᵢ^{[k,2]}, ηᵢ^{[k,2]}, and ξᵢ^{[k,2]} from δᵢ^{[k,2]}=E(Wᵢ⁻¹|Xᵢ;θ^{[k,2]}), ηᵢ^{[k,2]}=E(Wᵢ|Xᵢ;θ^{[k,2]}), and ξᵢ^{[k,2]}=E(ln(Wᵢ)|Xᵢ;θ^{[k,2]}), wherein θ^{[k,2]}=(λ^{[k]}, χ^{[k]}, ψ^{[k]}, μ^{[k+1]}, Σ^{[k+1]}, γ^{[k+1]})′; and
determining values of parameters λ, χ, ψ that maximize
$$( λ - 1 ) {\sum }_{i = 1}^{n} {ξ}_{i}^{[ k , 2 ]} - \frac{1}{2} χ {\sum }_{i = 1}^{n} {δ}_{i}^{[ k , 2 ]} - \frac{1}{2} ψ {\sum }_{i = 1}^{n} {η}_{i}^{[ k , 2 ]} - \frac{1}{2} n λ ln ( χ ) + \frac{1}{2} n λ ln ( ψ ) - n ln ( 2 {K}_{λ} ( \sqrt{χψ} ) ) .$$

30. The computer readable program storage device of claim 29, wherein γ^{[k+1]}=0 for a symmetric model.

31. The computer readable program storage device of claim 29, wherein ψ=0, λ=v/2 with a degrees of freedom parameter v>4, and χ=v.

32. The computer readable program storage device of claim 29, wherein said method is implemented on a computer having at least one multi-core processor, said cores are utilized in a master/slave layout wherein several master processes distribute data for W and X to many slave processes, wherein each slave received data for a single asset of said financial portfolio, and each slave process returns an estimate of the parameters \vec{θ}^{[k]}=(c, a₁, . . . , aₚ, b₁, . . . , b_{q}, ρ₁, . . . , ρᵣ, φ₁, . . . , φₛ, λ, χ, ψ, γ) to its master process.

33. The computer readable program storage device of claim 26, wherein estimating parameter values \vec{θ}=(c, a₁, . . . , aₚ, b₁, . . . , b_{q}, ρ₁, . . . , ρᵣ, φ₁, . . . , φₛ, λ, χ, ψ, γ) of a copula dependence structure for the standardized residuals uₜ comprises:
initializing parameter values \vec{θ}^{[0]}=(c, a₁, . . . , aₚ, b₁, . . . , b_{q}, ρ₁, . . . , ρᵣ, φ₁, . . . , φₛ, λ, χ, ψ, γ) for a multivariate generalized hyperbolic distribution;
calculating weights
$${\overline{δ}}^{[ k ]} = \frac{1}{n} {\sum }_{i = 1}^{n} {δ}_{i}^{[ k ]} , \\ and$$
$${\overline{η}}^{[ k ]} = \frac{1}{n} {\sum }_{i = 1}^{n} {η}_{i}^{[ k ]}$$
wherein δᵢ^{[k]}=E(Wᵢ⁻¹|Xᵢ;θ^{[k]}) and ηᵢ^{[k]}=E(Wᵢ|Xᵢ;θ^{[k]}) for a non-negative scalar random variable Wᵢ distributed as ƒ(x), wherein k is an iteration index;
updating parameter γ as
$${γ}^{[ k + 1 ]} = \frac{{n}^{- 1} {\sum }_{i = 1}^{n} {δ}_{i}^{[ k ]} ( \overline{X} - {X}_{i} )}{{\overline{δ}}^{[ k ]} {\overline{η}}^{[ k ]} - 1} ;$$
updating the mean μ and covariance matrix Σ as
$${μ}^{[ k + 1 ]} = \frac{{n}^{- 1} {\sum }_{i = 1}^{n} {δ}_{i}^{[ k ]} {X}_{i} - {γ}^{[ k + 1 ]}}{{\overline{δ}}^{[ k ]}}$$
$$and$$
$${Σ}^{[ k + 1 ]} = \frac{{\vert S \vert}^{1 / d} Ψ}{Ψ}$$
$$wherein$$
$$Ψ = \frac{1}{n} {\sum }_{i = 1}^{n} {δ}_{i}^{[ k ]} ( {X}_{i} - {μ}^{[ k + 1 ]} ) {( {X}_{i} - {μ}^{[ k + 1 ]} )}^{′} - {\overline{η}}^{[ k ]} {γ}^{[ k + 1 ]} {γ}^{[ k + 1 ] ′} ,$$
calculating weights δᵢ^{[k,2]}, ηᵢ^{[k,2]} and ξᵢ^{[k,2]} from δᵢ^{[k,2]}=E(Wᵢ⁻¹|Xᵢ;θ^{[k,2]}), ηᵢ^{[k,2]}=E(Wᵢ|Xᵢ;θ^{[k,2]}), and ξᵢ^{[k,2]}=E(ln(Wᵢ)|Xᵢ;θ^{[k,2]}), wherein θ^{[k,2]}=(λ^{[k]}, χ^{[k]}, ψ^{[k]}, μ^{[k+1]}, Σ^{[k+1]}, γ^{[k+1]})′; and
determining values of parameters λ, χ, ψ that maximize
$$( λ - 1 ) {\sum }_{i = 1}^{n} {ξ}_{i}^{[ k , 2 ]} - \frac{1}{2} χ {\sum }_{i = 1}^{n} {δ}_{i}^{[ k , 2 ]} - \frac{1}{2} ψ {\sum }_{i = 1}^{n} {η}_{i}^{[ k2 ]} - \frac{1}{2} n λ ln ( χ ) + \frac{1}{2} n λ ln ( ψ ) - n ln ( 2 {K}_{λ} ( \sqrt{χ ψ} ) ) .$$

34. The computer readable program storage device of claim 33, wherein the univariate generalized hyperbolic distribution is a one-dimensional Student's t distribution wherein ψ=0, λ=v/2 with a degrees of freedom parameter v>4, and χ=v, and further comprising performing said maximum likelihood estimation for each univariate Student's t distribution to obtain parameters (γᵢ, μᵢ, vᵢ, σᵢ) for i=1, . . . , d wherein d is a number of dimensions, estimating v from
$$v = \frac{1}{d} {\sum }_{i = 1}^{d} {v}_{i} ,$$
estimating a covariance Σ from
$$Σ = \frac{v - 2}{v} ( cov ( X ) - \frac{2 {v}^{2}}{{( v - 2 )}^{2} ( v - 4 )} {γγ}^{′} )$$
wherein X is a random vector, and adjusting Σ to be positive definite.

35. The computer readable program storage device of claim 26, wherein a dependence structure for \vec{U} is estimated from
$$f ( {X}^{} ) = c \frac{{K}_{\frac{v + d}{2}} ( \sqrt{v + {( {X}^{} - {μ}^{} )}^{′} {Σ}^{- 1} ( {X}^{} - {μ}^{} ) ) {{γ}^{->}}^{′} {Σ}^{- 1} {γ}^{->}} exp ( {X}^{} - {μ}^{} ) {Σ}^{- 1} {γ}^{->} )}{\begin{matrix}{( \sqrt{( v + {( {X}^{} - {μ}^{} )}^{′} {Σ}^{- 1} ( {X}^{} - {μ}^{} ) ) {{γ}^{->}}^{′} {Σ}^{- 1} {γ}^{->}} )}^{- \frac{v + d}{2}} \\ {( 1 + \frac{{( {X}^{} - {μ}^{} )}^{′} {Σ}^{- 1} {γ}^{->}}{v} )}^{\frac{v + d}{2}}\end{matrix}}$$
wherein Kₐ is a modified Bessel function of the third kind, and c is a normalizing constant defined as
$$c = \frac{{2}^{\frac{2 - ( v + d )}{2}}}{Γ ( \frac{v}{2} ) {( π v )}^{d / 2} {\vert Σ \vert}^{1 / 2}} .$$

36. The computer readable program storage device of claim 26, wherein the ARMA-GARCH model has a nearly elliptical distribution, and calculating a portfolio risk forecast comprises:
drawing a plurality N of independent random samples from the dependence structure for \vec{U};
transforming these samples into copula space using a sample cumulative distribution function Fₖ of a k-th marginal using
$${F}_{k} ( x ) = \frac{1}{n} {\sum }_{j = - 1}^{n} {1}_{\{ {S}_{j , k \leq x} \}} ;$$
forecasting \tilde{X}=(r_{t+1,1}, . . . , r_{t+1,d})_{j=1, . . . , n}′ for each asset using the estimated parameter values \vec{θ}; and
calculating a Value-at-Risk VaR from G(VaRₛ)=∫_{VaR}_{ₛ}^{∞}ƒ_{\tilde{Y}}_{ₛ}(y)dy+α−1 wherein α is a confidence level for the VaR, \tilde{Y}ₛ is defined as \tilde{Y}ₛ=\tilde{Y}− [symbol] \vec{w},\vec{μ} [symbol] wherein \tilde{Y}= [symbol] \vec{w},\tilde{X} [symbol] , \vec{w}∈R^{d} is a vector of portfolio weights, \tilde{X}_{T}=(r_{T,1}, . . . , r_{T,d}) is a vector of losses for d assets at time T, and \vec{μ} is defined by \tilde{X}_{T}=\vec{μ}_{T-1}+D_{T-1}Ũ_{T}, wherein D_{T-1}Ũ_{T}=ε_{T} is a time T innovation with D_{T-1}∈R^{d×d} and \vec{μ}_{T-1}∈R^{d} is an ARMA GARCH prediction, and ƒ_{\tilde{Y}}_{ₛ} is a marginal of a probability with respect to \tilde{Y}ₛ.

37. The method of claim 36, wherein drawing a plurality N of independent random samples from the dependence structure for \vec{U} comprises:
sampling a plurality N of independent d-dimensional vectors from a multivariate normal distribution N(0, Σ);
sampling a plurality N of independent random numbers from a Generalized inverse Gaussian distribution
$$f ( x ) = \frac{{{χ}^{- λ} ( \sqrt{χψ} )}^{λ}}{2 {K}_{λ} ( \sqrt{χψ} )} {x}^{λ - 1} exp ( - \frac{1}{2} ( χ {x}^{- 1} + ψ x ) )$$
x>0; and
combining these samples to obtain a multivariate generalized hyperbolic sample.

38. The computer readable program storage device of claim 37, further comprising sorting the plurality N of independent random samples into bins indexed by nonspherical directions of the multivariate generalized hyperbolic distribution and by the direction of a spherically transformed portfolio.

39. The method of claim 37, wherein sampling a plurality N of independent d-dimensional vectors from a multivariate normal distribution N(0, Σ) comprises:
computing a Cholesky decomposition A of Σ;
simulating N independent random varieties z=(z₁, . . . , z_{d})′ from N(I_{d}, 0), where I_{d} is a d-dimensional identity matrix; and
generating a Gaussian sample from X:=μ+Az, wherein μ is a sample mean.

40. The computer readable program storage device of claim 26, wherein transforming the standardized residuals uₜ into copula space is performed for an asset on a same computer node as that used to estimate parameter values \vec{θ} for that asset.
